(19) United States
(12) Patent Application Publication
(10) Pub. No.: US 2026/0075495 A1
(43) Pub. Date: Mar. 12, 2026

(54) EARLY CONDITIONAL HANDOVER PROCEDURE

(71) Applicant: QUALCOMM Incorporated, San Diego, CA (US)

(72) Inventors: Ming YANG, San Diego, CA (US); Kausik RAY CHAUDHURI, San Diego, CA (US); Juan MONTOJO, San Diego, CA (US)

(21) Appl. No.: 19/285,918

(22) Filed: Jul. 30, 2025

Related U.S. Application Data
(60) Provisional application No. 63/692,664, filed on Sep. 9, 2024.

(51) Int. Cl. H04W 36/36; H04L 41/16; H04W 72/231; H04W 76/20

(52) U.S. Cl. CPC H04W 36/362; H04L 41/16; H04W 72/231; H04W 76/20

(57) ABSTRACT

Various aspects of the present disclosure generally relate to wireless communication. In some aspects, a user equipment (UE) may receive an early conditional handover (CHO) indication configuration including a set of one or more early CHO indication activation parameters for transmitting an early CHO indication. The UE may transmit, to a source network node in accordance with the early CHO indication configuration, the early CHO indication prior to at least one CHO execution condition being satisfied, the early CHO indication including a set of parameters for middle data forwarding during a CHO procedure. In some aspects, the CHO procedure includes at least one of a Layer 1 handover procedure or a Layer 3 handover procedure. Numerous other aspects are described.

### CROSS-REFERENCE TO RELATED APPLICATION

This Patent Application claims priority to U.S. Provisional Patent Application No. 63/692,664, filed on Sep. 9, 2024, entitled “EARLY CONDITIONAL HANDOVER PROCEDURE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods for early conditional handover procedure.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a conditional handover (CHO) procedure, in accordance with the present disclosure.

FIG. 5 is a diagram illustrating an example of a handover procedure timeline and an example of a CHO procedure timeline, in accordance with the present disclosure.

FIG. 6 is a diagram of an example associated with early CHO indication, in accordance with the present disclosure.

FIG. 7 is a diagram illustrating an example of transmitting an early CHO indication, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a source network node or an apparatus of a source network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### SUMMARY

In some aspects, an apparatus for wireless communication at a user equipment (UE) includes one or more memories; and one or more processors, coupled to the one or more memories, configured to cause the UE to: receive an early conditional handover (CHO) indication configuration including a set of one or more early CHO indication activation parameters for transmitting an early CHO indication; and transmit, to a source network node in accordance with the early CHO indication configuration, the early CHO indication prior to at least one CHO execution condition being satisfied, the early CHO indication including a set of parameters for middle data forwarding during a CHO procedure.

In some aspects, an apparatus for wireless communication at a network node includes one or more memories; and one or more processors, coupled to the one or more memories, configured to cause the network node to: transmit an early CHO indication configuration including a set of one or more early CHO indication activation parameters for communicating an early CHO indication; and receive, from a UE in accordance with the early CHO indication configuration, the early CHO indication prior to at least one CHO execution condition being satisfied, the early CHO indication including a set of parameters for performing middle data forwarding during a CHO procedure.

In some aspects, a method of wireless communication performed by a UE includes receiving an early CHO indication configuration including a set of one or more early CHO indication activation parameters for transmitting an early CHO indication; and transmitting, to a source network node in accordance with the early CHO indication configuration, the early CHO indication prior to at least one CHO execution condition being satisfied, the early CHO indication including a set of parameters for middle data forwarding during a CHO procedure.

In some aspects, a method of wireless communication performed by a network node includes transmitting an early CHO indication configuration including a set of one or more early CHO indication activation parameters for communicating an early CHO indication; and receiving, from a UE in accordance with the early CHO indication configuration, the early CHO indication prior to at least one CHO execution condition being satisfied, the early CHO indication including a set of parameters for performing middle data forwarding during a CHO procedure.

In some aspects, a non-transitory computer-readable medium storing a set of instructions for wireless communication includes one or more instructions that, when executed by one or more processors of a UE, cause the UE to: receive an early CHO indication configuration including a set of one or more early CHO indication activation parameters for transmitting an early CHO indication; and transmit, to a source network node in accordance with the early CHO indication configuration, the early CHO indication prior to at least one CHO execution condition being satisfied, the early CHO indication including a set of parameters for middle data forwarding during a CHO procedure.

In some aspects, a non-transitory computer-readable medium storing a set of instructions for wireless communication includes one or more instructions that, when executed by one or more processors of a network node, cause the network node to: transmit an early CHO indication configuration including a set of one or more early CHO indication activation parameters for communicating an early CHO indication; and receive, from a UE in accordance with the early CHO indication configuration, the early CHO indication prior to at least one CHO execution condition being satisfied, the early CHO indication including a set of parameters for performing middle data forwarding during a CHO procedure.

In some aspects, an apparatus for wireless communication includes means for receiving an early CHO indication configuration including a set of one or more early CHO indication activation parameters for transmitting an early CHO indication; and means for transmitting, to a source network node in accordance with the early CHO indication configuration, the early CHO indication prior to at least one CHO execution condition being satisfied, the early CHO indication including a set of parameters for middle data forwarding during a CHO procedure.

In some aspects, an apparatus for wireless communication includes means for transmitting an early CHO indication configuration including a set of one or more early CHO indication activation parameters for communicating an early CHO indication; and means for receiving, from a UE in accordance with the early CHO indication configuration, the early CHO indication prior to at least one CHO execution condition being satisfied, the early CHO indication including a set of parameters for performing middle data forwarding during a CHO procedure.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification, accompanying drawings, and the appendix.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communications systems may support handover procedures in which a user equipment (UE) ceases communications with a first network node (e.g., a source network node) and transitions to communicating with a second network node (e.g., a target network node). In some examples, as a UE and/or a source network node moves, the UE may switch from communicating with a first serving cell (e.g., associated with the source network node) to communicating with a second serving cell (e.g., associated with the target network node) based on a quality of the communication links between the UE and the first serving cell and/or the second serving cell. For example, as the UE and/or the first network node moves, the quality of the communication link between the UE and the first serving cell (e.g., facilitated by the first network node) may degrade. In such examples, the first network node may trigger the UE to perform a handover procedure (e.g., switch to communicating with a network node associated with a more suitable communication link). In some other examples, as the UE and/or the first network node moves, the UE and or the first network node may determine that a quality of communications between the UE and the second network node is associated with a higher quality and/or reliability than the communication link between the UE and the first network node. In such examples, the first network node may trigger the UE to perform a handover procedure (e.g., switch to communicating with the second network node associated with the more suitable communication link).

In some examples, a UE may be configured with conditional handover (CHO) and/or may be configured to perform a CHO procedure. In CHO, the source network node may configure the UE with one or more triggering conditions for when CHO is to be executed. For example, a CHO trigger condition may include detection of a specified value of a channel measurement and/or satisfaction of a threshold by a channel measurement, among other examples. Multiple candidate target cells may be prepared in association with multiple target network nodes and, when one or more triggering conditions are satisfied, the UE may perform and/or trigger the handover independently from the network. Using CHO, handover commands may be sent before radio conditions become poor, thereby increasing the chance of successful handover.

However, when the UE autonomously performs handover, the UE may cease communications with the source network node. Because the UE has independently triggered a handover procedure, the source network node may be unaware that the UE has ceased communications with the source network node. As a result, the source network node may schedule uplink and/or downlink communications with the UE while communications have been ceased, resulting in potentially missed communications.

Additionally, the source network node may not be indicated with which target network node the UE has selected for the CHO procedure and thus may be prevented from forwarding data to the selected target network node. For example, the source network node may perform early data forwarding to the core network prior to the execution of the CHO procedure, however such operations may be resource intensive due to backhaul operations used to communicate the data to the UE. The source network node may perform later data forwarding once the CHO procedure is complete. However, there remains a relatively long period of time between early data forwarding (which is costly to perform and as a result is often skipped) and later data forwarding, in which the data potentially communicated during execution of the CHO procedure may be missed and/or interrupted due to the lack of information at the network node regarding the performance of the CHO procedure.

Various aspects relate generally to an early CHO indication procedure in which a UE may predict one or more parameters (e.g., may predict that one or more trigger conditions will be satisfied and/or may predict one or more parameters associated with the performance of the CHO procedure) for middle data forwarding during a CHO procedure and may transmit an indication of the predicted one or more parameters to a source network node such that the network node may perform a data forwarding procedure (e.g., a mid-CHO data forwarding procedure, a data forwarding procedure that occurs between early data forwarding and later data forwarding, a middle data forwarding procedure, an intermediate data forwarding procedure, an intermediary data forwarding procedure, and/or a mid-forwarding procedure, each of which may be used to refer to a data forwarding procedure occurring in a middle portion of a CHO procedure). The data forwarding procedure may refer to a data forwarding procedure occurring relative to an early data forwarding procedure and a later data forwarding procedure. For example, the early data forwarding procedure may occur during an initial portion of the CHO procedure and the later data forwarding procedure may occur during a final portion of the CHO procedure. The data forwarding procedure may occur during a middle portion of the CHO procedure that occurs after the early data forwarding and before the later data forwarding. Thus, the data forwarding procedure may be referred to as any of a mid-CHO data forwarding procedure, a middle data forwarding procedure, an intermediate data forwarding procedure, an intermediary data forwarding procedure, and/or a mid-forwarding procedure, interchangeably.

Some aspects more specifically relate to the network node forwarding the data to a target network node indicated by the UE, after forwarding user data to a core network (e.g., after early data forwarding) in response to a handover success indication (e.g., before later data forwarding). In some aspects, a UE may receive an early CHO indication configuration including a set of one or more early CHO indication activation parameters for transmitting an early CHO indication. The UE may transmit the early CHO indication to a source network node according to the early CHO indication configuration. The early CHO indication may indicate parameters for middle data forwarding during a CHO procedure and/or for a network node data forwarding procedure (e.g., middle data forwarding). In some aspects, the early CHO indication is transmitted prior to at least one CHO execution condition being satisfied. In some examples, the CHO execution may include one or more channel quality conditions.

Some aspects more specifically relate to the UE predicting that one or more conditions for triggering a CHO procedure (e.g., one or more CHO initiation and/or trigger conditions) will be satisfied. For example, the UE may predict the set of parameters for performing the CHO procedure using an artificial intelligence (AI) or machine learning (ML) (AI/ML) module and/or using a set of historical data associated with performance of the CHO procedure. Additionally or alternatively, the UE 120 may predict one or more parameters associated with performing the CHO procedure such as a time at which the CHO procedure will be performed, and with which target network node. As a result, the UE 120 may indicate the predicted one or more parameters associated with performing the CHO procedure to the network node 110.

Particular aspects of the subject matter described in this disclosure can be implemented to realize one or more of the following potential advantages. In some aspects, by receiving the early CHO indication configuration, the described techniques can be used to enable early CHO indication at the UE such that the source network node and the UE are prepared to perform one or more actions in association with communicating the early CHO indication to trigger middle data forwarding without additional signaling. In some aspects, by predicting the one or more parameters associated with performing the CHO procedure, the described techniques can be used to predict parameters associated with a future CHO procedure such that the UE may communicate the predicted parameters while a signal quality associated with communications between the UE and the source network node is stable (e.g., before the predicted conditions occur which may be associated with poor signal quality between the UE and the source network node). In some aspects, by the UE indicating the predicted one or more parameters associated with performing the CHO procedure to the network node 110, the described techniques can be used to prompt the network node to perform the middle data forwarding procedure with the target network node indicated by the early CHO indication without additional indication from the UE 120 that the CHO is being performed. As a result, the reduced overhead and complexity associated with CHO may be preserved while the amount of time that the UE and/or the network node experiences data interruption may be reduced.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or AI/ML, among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

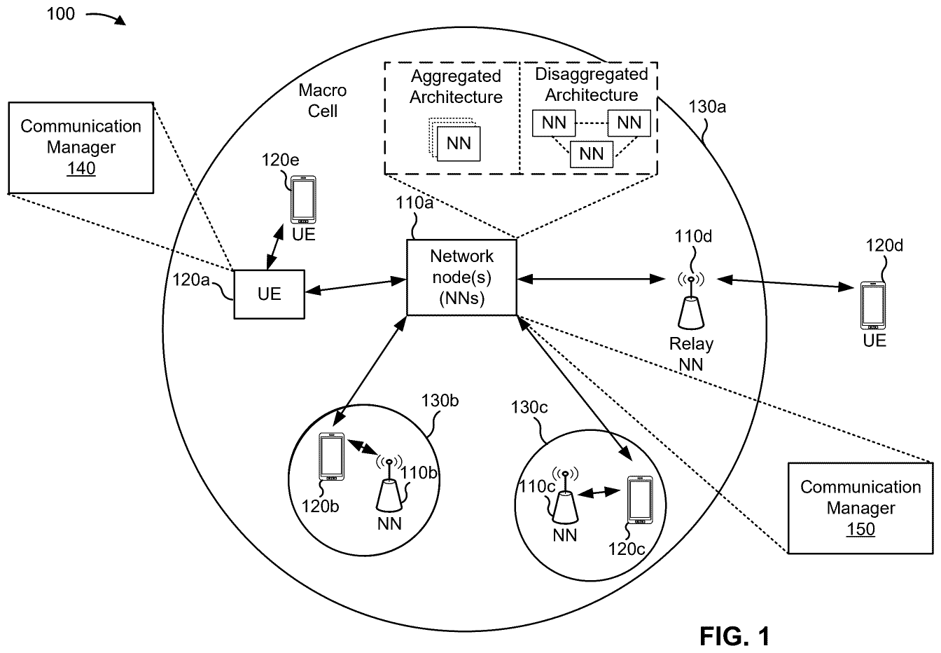

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an early CHO indication configuration including a set of one or more early CHO indication activation parameters for transmitting an early CHO indication; and transmit, to a source network node in accordance with the early CHO indication configuration, the early CHO indication prior to at least one CHO execution condition being satisfied, the early CHO indication including a set of parameters for middle data forwarding during a CHO procedure. Additionally, or alternatively, the communication manager 140 may perform one or more other operations described herein.

In some aspects, the network node 110 may include a communication manager 150. As described in more detail elsewhere herein, the communication manager 150 may transmit an early CHO indication configuration including a set of one or more early CHO indication activation parameters for communicating an early CHO indication; and receive, from a UE in accordance with the early CHO indication configuration, the early CHO indication prior to at least one CHO execution condition being satisfied, the early CHO indication including a set of parameters for performing middle data forwarding during a CHO procedure. Additionally, or alternatively, the communication manager 150 may perform one or more other operations described herein.

As indicated above, FIG. 1 is provided as an example. Other examples may differ from what is described with regard to FIG. 1.

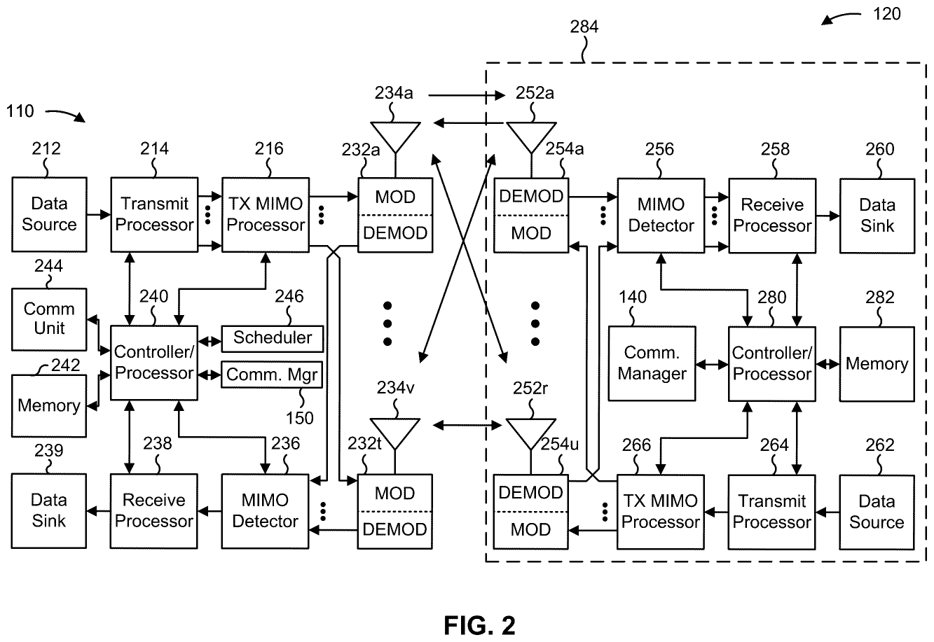

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects, in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects, in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

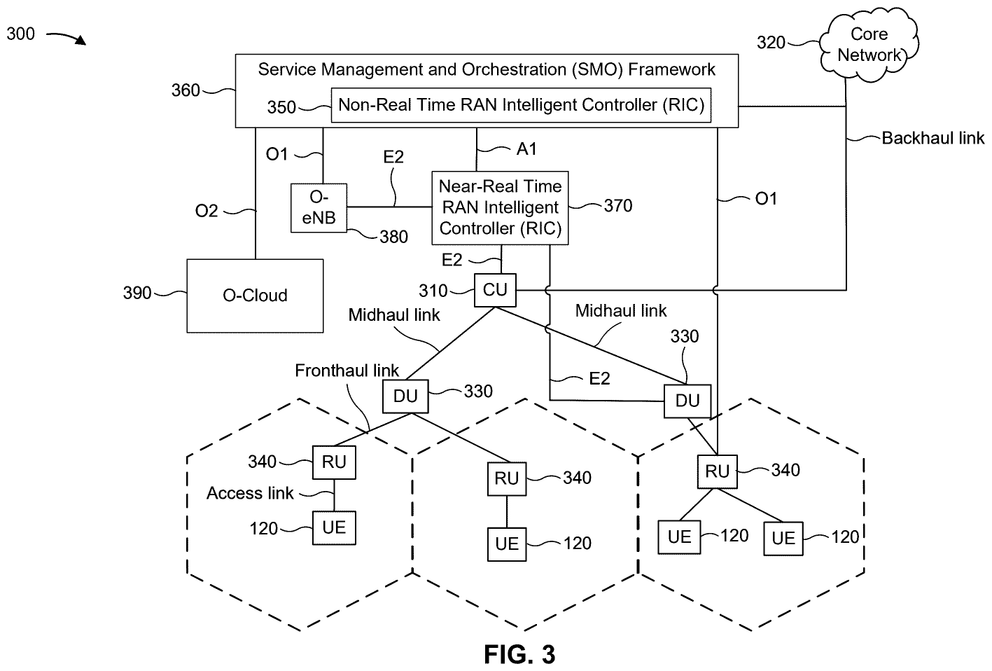

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

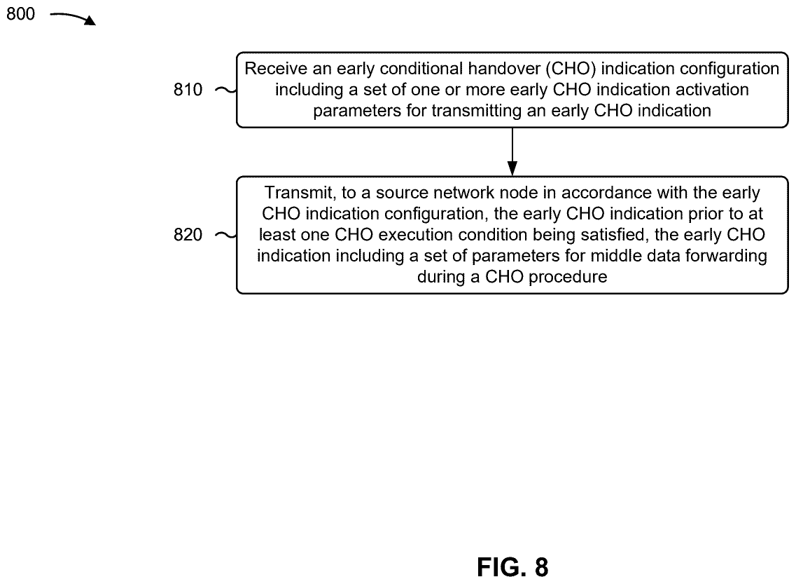

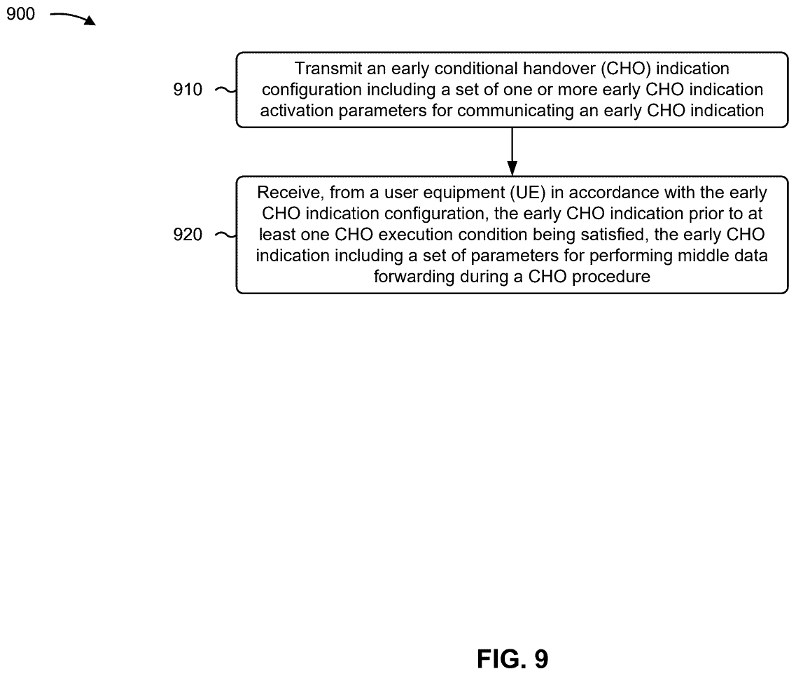

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with early CHO indication, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

In some aspects, the UE includes means for receiving an early CHO indication configuration including a set of one or more early CHO indication activation parameters for transmitting an early CHO indication; and/or means for transmitting, to a source network node in accordance with the early CHO indication configuration, the early CHO indication prior to at least one CHO execution condition being satisfied, the early CHO indication including a set of parameters for middle data forwarding during a CHO procedure. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an early CHO indication configuration including a set of one or more early CHO indication activation parameters for communicating an early CHO indication; and/or means for receiving, from a UE in accordance with the early CHO indication configuration, the early CHO indication prior to at least one CHO execution condition being satisfied, the early CHO indication including a set of parameters for performing middle data forwarding during a CHO procedure. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

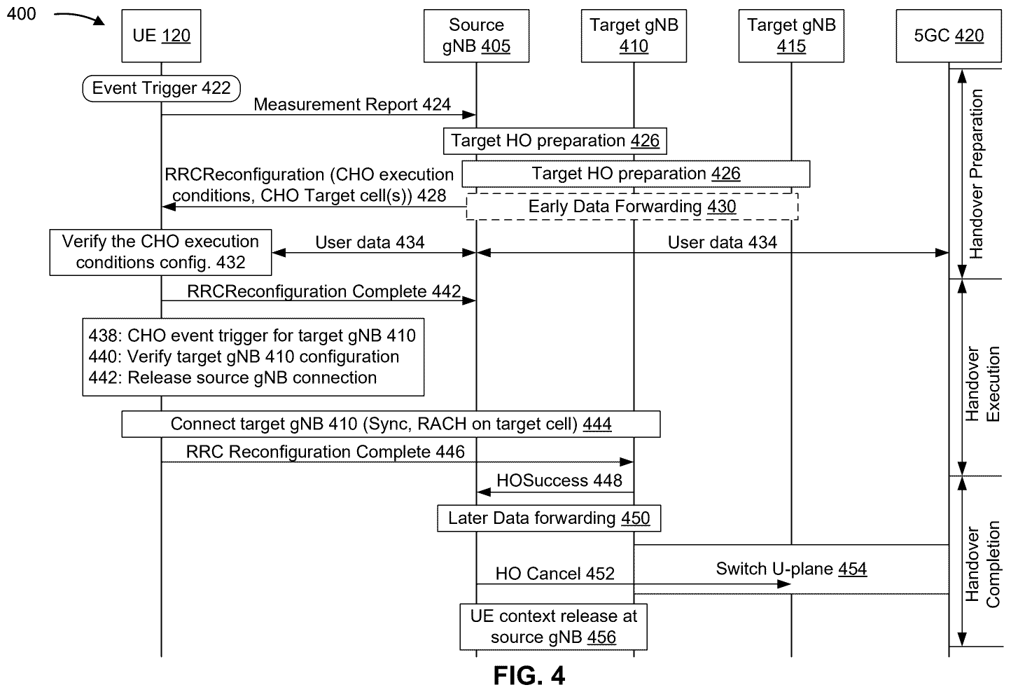

FIG. 4 is a diagram illustrating an example 400 of transmitting an early bye message, in accordance with the present disclosure. A source network entity, such as gNB 405 (e.g., base station 110), may provide a source cell for a UE (e.g., UE 120). The UE 120 may be handed over from the source cell to a candidate target cell provided by either candidate target gNB 410 (e.g., a base station 110) or candidate target gNB 415 (e.g., a base station 110). Each of the gNBs may be connected to a 5G core network (5GC 420).

CHO may include several phases. The phases may include a handover preparation phase, a handover execution phase, and a handover completion phase. In some aspects, the UE 120 may make and report measurements during the handover preparation phase. There may be multiple candidate target cells, such as target cells provided by target gNB 410 and target gNB 415. Selection to a particular target cell, such as the target cell provided by target gNB 410, may be based on meeting a condition of the particular target cell. During the handover execution phase, the UE 120 may execute the handover by performing a random access channel (RACH) procedure with the target gNB 410 and establishing a radio resource control (RRC) connection with the target gNB 410. During the handover completion phase, the source gNB 405 may forward stored communications associated with the UE 120 to the target gNB 410, and the UE 120 may be released from the source connection to the source gNB 405.

CHO may involve multiple steps in each of the handover phases. As shown by reference number 422, the UE 120 may determine that an event trigger or handover condition is being met. The UE 120 may perform measurements (such as on signals of the source cell or neighboring cells) and transmit a measurement report to the source gNB 405 of the source cell, as shown by reference number 424. The measurement report may indicate, for example, an RSRP parameter, an RSRQ parameter, an RSSI parameter, or a signal-to-interference-plus-noise ratio (SINR) parameter.

As shown by reference number 426, the source gNB 405 and each candidate target gNB of the candidate target cells may prepare for a handover. As shown by reference number 428, the source gNB 405 may transmit an RRC reconfiguration message to the UE 120. The RRC reconfiguration message may include a handover command instructing the UE 120 to execute the CHO from the source gNB 405 to one of the candidate target gNBs. The handover command may include information associated with each candidate target gNB, including a condition (e.g., threshold) for a handover to a particular candidate target gNB, such as target gNB 410. The UE 120 may simultaneously maintain the source connection to the source gNB 405 and a target connection to the target gNB 410.

As shown by reference number 430, the source gNB 405 may start forwarding user data when the target cell is prepared (referred to as “early forwarding”). When the CHO is executed successfully, the source gNB 405 may also forward data (referred to as “late forwarding”). In some cases, a gNB may implement late forwarding, since early forwarding could be wasteful if the CHO is never executed. On the other hand, there is potential data lost with late forwarding, since after the time the UE 120 leaves the source gNB 405 and the CHO is completed, the source gNB 405 will continue transmitting data to the UE 120 which will not be received, and such data either will need to be recovered by retransmission or will be lost completely.

In some aspects, the RRC reconfiguration message may include a candidate target cell configuration and CHO execution conditions by which the UE 120 is to prepare for a CHO. The execution conditions may include an A3 conditional event, where measurements for a candidate target cell become better by a first threshold amount (e.g., specified offset of 3 decibels (dB)) than measurements for a current cell (PCell or PSCell). The execution conditions may include an A5 event, where the measurements at the current cell become worse by a second threshold amount (e.g., offset in dB) and the measurements for the candidate target cell become better than a third threshold amount (e.g., absolute amount in dB). The UE 120 may monitor for conditional events such as A3 and A5 during a time to trigger (TTT) period, which may involve a TTT timer.

An RRC container may carry a candidate target cell configuration, and the source gNB 405 may not be allowed to alter any content of the candidate target cell configuration. Multiple candidate target cells (e.g., up to 8) may be configured. These may include delta configurations, which may be configurations that provide only a difference between a candidate target cell configuration and a configuration of the source gNB 405. The source gNB 405 may coordinate with a target gNB when there are any source or target changes and may update the UE 120. As shown by reference number 432, the UE 120 may verify the validity of the configuration of the source gNB 405 configuration upon reception. The CHO execution condition configuration may specify that the CHO entry condition is to be satisfied before the TTT ends (e.g., with an exit condition). A CHO execution condition configuration may include triggering quantities of RSRP, RSRP, and SINR that are configured simultaneously. There may be a single reference signal type, such as a synchronization signal block (SSB) or a channel state information reference signal (CSI-RS), per CHO candidate target cell.

If reconfiguration with synchronization (with or without key change) happens before CHO execution conditions are met, the UE 120 may delete stored CHO configurations. When a radio link failure occurs, if a selected target cell is a CHO candidate target cell, the UE 120 may perform CHO completion. If not, legacy reestablishment may be performed. As shown by reference number 434, UE 120 may be transmitting user data to and receiving user data from the source gNB 405, which communicates the user data with the 5GC 420. The source gNB 405 and the target gNB 410 may exchange user data for the UE 120.

As shown by reference number 436, the UE 120 may transmit an RRC reconfiguration complete message to the source gNB. As shown by reference number 438, the UE 120 may determine that an event is triggered for handover to the target cell for the target gNB 410. As shown by reference number 440, the UE 120 may verify a configuration of the target gNB 410. Verification may take place at an earlier time. As shown by reference number 442, the UE 120 may release the source connection to the source cell and execute the CHO to the target gNB 410.

As shown by reference number 444, the UE 120 may connect to the target gNB 410 as part of the handover execution phase. The UE 120 may connect to the target gNB 410 by performing a RACH procedure with the target gNB 410. Upon successfully establishing a connection with the target gNB 410, the UE 120 may transmit an RRC reconfiguration completion message to the target gNB 410, as shown by reference number 446. A difference between CHO and legacy handover is that the UE 120 does not need to send the measurement report to the source gNB 405 and wait for a handover command. This makes the CHO more robust for cases when the source cell conditions degrade rapidly. In addition, CHO improves the handover latency by eliminating reporting and handover command reception.

As shown by reference number 448, the target gNB 410 may transmit a handover connection setup complete message (e.g., HOSuccess) to the source gNB 405. Reception of the handover connection setup complete message by the target gNB 410 may trigger the source gNB 405 to stop transmitting data to the UE 120 or to stop receiving data from the UE 120.

When the CHO execution condition is met for a candidate target cell, a timer may be used for CHO completion. The UE 120 does not monitor source cell transmissions afterwards and does not receive new RRC messages. The UE 120 stops transmissions to the source cell. The UE 120 may transmit a handover complete message to the target cell, as in legacy handover. The UE 120 may stop evaluating the triggering condition of other candidate cells during CHO execution (may still perform measurements on them).

As shown by reference number 450, the source gNB 405 may perform later data forwarding. For example, the source gNB 405 may forward communications associated with the UE 120 to the target gNB 410 or to notify the target gNB 410 of a status of one or more communications with the UE 120. The source gNB 405 may notify the target gNB 410 regarding a packet data convergence protocol (PDCP) status associated with the UE 120 or a serial number to be used for a downlink communication with the UE 120.

If CHO completion fails (e.g., the timer expires), the UE 120 may perform cell selection using a legacy procedure. If the selected cell is a CHO candidate, the UE 120 may attempt to complete CHO to the selected cell. This is an optional UE capability. Otherwise, the UE 120 follows legacy reestablishment. As shown by reference number 452, the source gNB 405 may transmit a handover cancel message to any candidate target gNBs that the UE 120 did not select for handover. For example, the source gNB 405 may transmit a handover cancel message to the target gNB 415.

The target gNB 410 may communicate with the 5GC 420 to switch a user plane path of the UE 120 from the source gNB 405 to the target gNB 410, as shown by reference number 454. Prior to switching the user plane path, downlink communications for the UE 120 may be routed through the 5GC 420 to the source gNB 405. After the user plane path is switched, downlink communications for the UE 120 may be routed through the 5GC 420 to the target gNB 410. As shown by reference number 456, the source gNB 405 may release a UE context for the UE 120.

In dual connectivity scenarios, a secondary node (SN) of a cell may be used with a primary node of a cell to increase a bandwidth or a performance for a UE. Traffic on the primary node and the SN may be aggregated. In such a scenario, the UE may change SNs. This may be referred to as conditional “primary secondary cell (PSCell) change” for NR. In some aspects, the change may be performed with operations comparable to a dual active protocol stack (DAPS) handover, a CHO, or another type of handover. The UE may decide to change from the source secondary cell (SCell) to a target SCell. The UE may decide this change based on, for example, measurements from the source SCell or the target SCell.

The CHO may include a DAPS handover from the source gNB 405 to the target gNB 410. The UE 120 may connect to the target gNB 410 as part of the handover execution phase and transmit uplink data, uplink control information, or an uplink reference signal (such as a sounding reference signal) to the source gNB 405, or may receive downlink data, downlink control information, or a downlink reference signal from the source gNB 405. While the UE 120 is performing the RACH procedure with the target gNB 410, the UE 120 may transmit uplink data, uplink control information, or an uplink reference signal (such as a sounding reference signal) to the source gNB 405, or may receive downlink data, downlink control information, or a downlink reference signal from the source gNB 405. Because the DAPS handover may be a make before break (MBB) handover, the UE 120 may simultaneously maintain the source connection with the source gNB 405 and the target connection with the target gNB 410.

The UE 120 may initiate the CHO procedure based on a handover condition being satisfied, which may be at the certain (earlier) point of the TTT timer. This may involve another timer that is started when the event entering condition is satisfied. The handover condition may include a threshold gradient of signal strength, a threshold gradient of signal quality, a threshold Doppler parameter, or a threshold velocity of the UE. The handover condition may be satisfied, for example, when a measured gradient of signal strength meets or exceeds a gradient threshold of signal strength, when a measured gradient of signal quality meets or exceeds a gradient threshold of signal quality, when a Doppler parameter meets a Doppler parameter threshold, or when a velocity of the UE 120 meets or exceeds a velocity threshold. The handover condition may include other aspects of UE mobility and signal characteristics.

As indicated above, FIG. 4 is provided as an example. Other examples may differ from what is described with regard to FIG. 4.

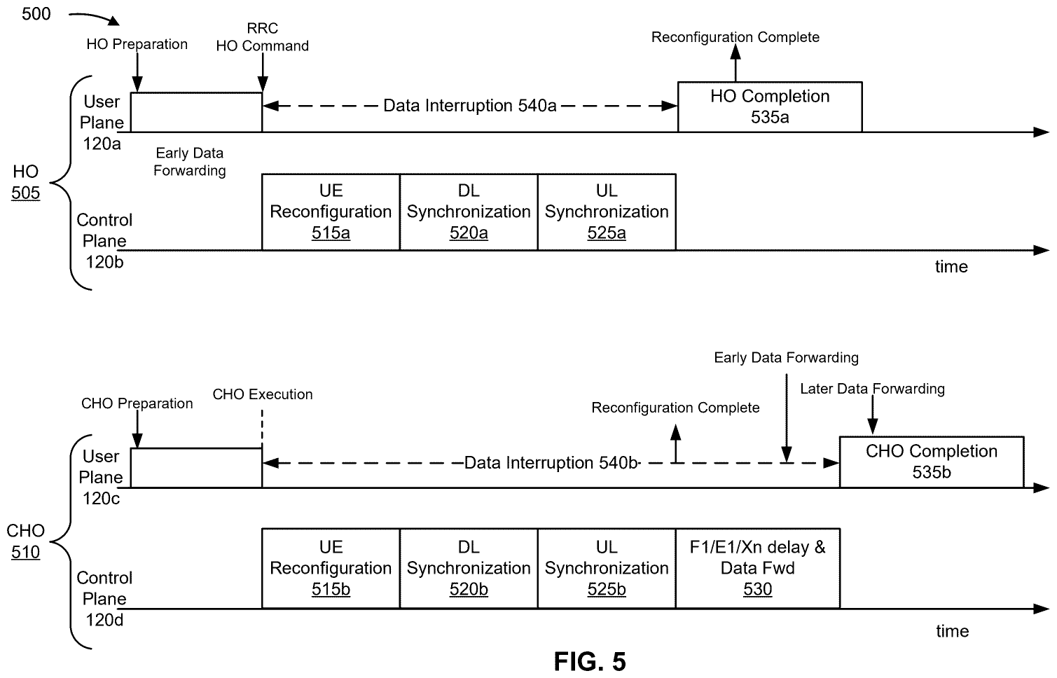

FIG. 5 is a diagram illustrating an example 505 of a handover procedure timeline and an example 510 of a CHO procedure timeline, in accordance with the present disclosure.

In the example 505, a UE (e.g., such as UE 120 described in connection with reference number FIGS. 1-3) may be configured to perform a handover procedure. For example, a user plane 120a of the UE may perform one or more actions as part of handover preparation. The UE may receive a handover command from a source network node (e.g., such as a network node 110 described in connection with reference number FIGS. 1-3) via RRC signaling. A control plane 120b of the UE may perform reconfiguration 515a, DL synchronization 520a, and/or UL synchronization 525a as part of the handover procedure. While the control plane 120b of the UE is performing the actions associated with the handover procedure, the user plane 120a of the UE may cease data communications with the source network node, resulting in a period of time, data interruption 540a, in which data may be interrupted an/or missed that lasts until handover completion 535a and/or later data forwarding occurs. In such examples, some data forwarding may occur before the data interruption 540a.

In the example 510, the UE (e.g., such as UE 120 described in connection with reference number FIGS. 1-3) may be configured to perform a CHO procedure. For example, a user plane 120c of the UE may perform one or more actions as part of CHO preparation. The UE may determine one or more conditions for triggering the CHO procedure have been satisfied and may execute the CHO procedure. A control plane 120d of the UE may perform reconfiguration 515b, DL synchronization 520b, UL synchronization 525b, and/or F1/E1/Xn delay and data forwarding 530 (e.g., early data forwarding as described herein) as part of the CHO procedure. While the control plane 120d of the UE is performing the actions associated with the handover procedure, the user plane 120c of the UE may cease data communications with the source network node, resulting in a period of time, data interruption 540b, in which data may be interrupted an/or missed that lasts until handover completion 535b.

In the example 510, the UE has independently triggered a handover procedure independent from network signaling which may be beneficial to overhead and resource costs, however the source network node may be unaware that the UE has ceased communications with the source network node. As a result, the source network node may schedule uplink and/or downlink communications with the UE during the data interruption 540, which may be longer in duration than the data interruption 540a, resulting in potentially missed communications for a greater amount of time in exchange for the lower overhead costs associated with CHO. For example, in CHO there may be a duration of time between early data forwarding and later data forwarding in which errors may occur that is additional with respect to data interruption 540a. Further, the source network node may not be indicated with which target network node the UE has selected for the CHO procedure and thus may be prevented from forwarding data during the data interruption 540b to the selected target network node and thus may perform early data forwarding with a core network of the UE. For example, the source network node may perform early data forwarding to the core network prior to the completion of the CHO procedure, however such operations may be resource intensive due to backhaul operations used to communicate the data to the UE. The source network node may perform later data forwarding during completion of the CHO procedure. However, there remains a relatively long period of time between early data forwarding (which is costly to perform and as a result is often skipped) and later data forwarding, in which the data potentially communicated during execution of the CHO procedure may be missed and/or interrupted due to the lack of information at the network node regarding the performance of the CHO procedure.

As indicated above, FIG. 5 is provided as an example. Other examples may differ from what is described with respect to FIG. 5.

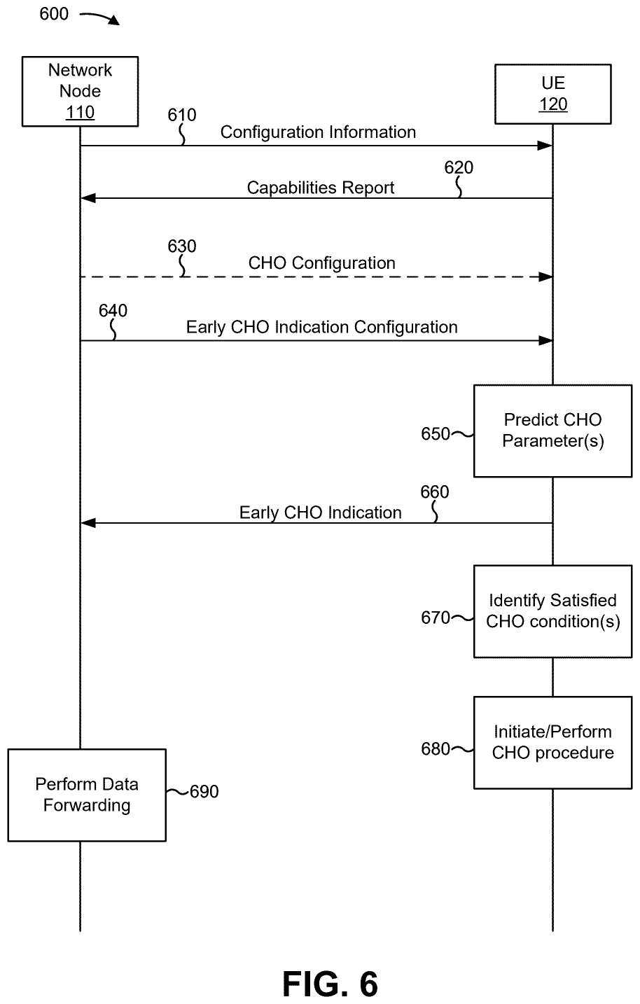

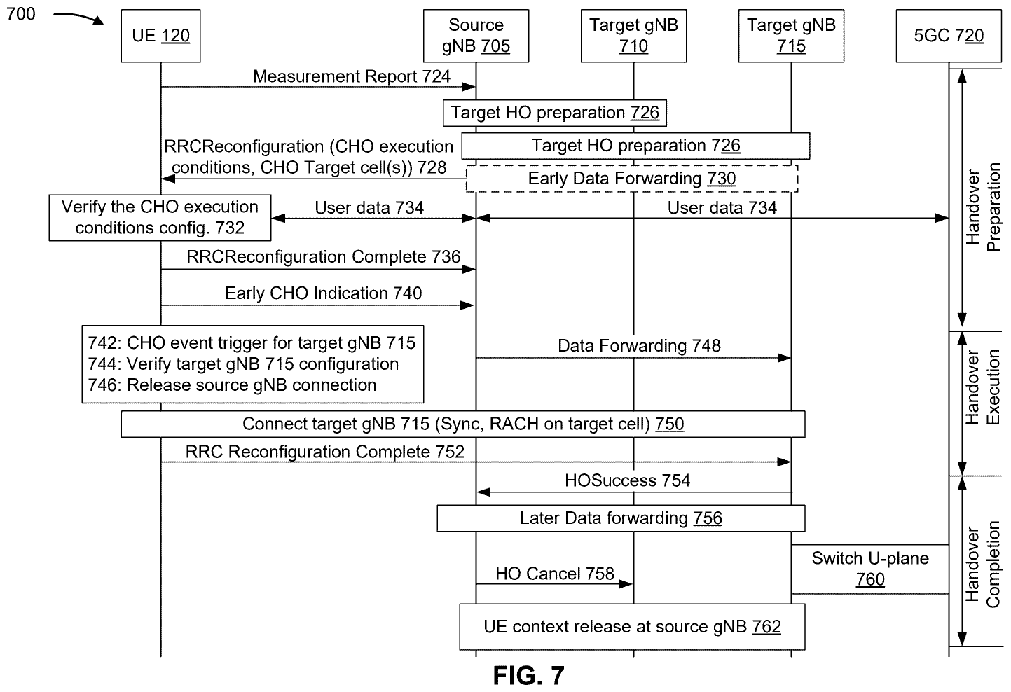

FIG. 6 is a diagram of an example 600 associated with early CHO indication, in accordance with the present disclosure. As shown in FIG. 6, a network node 110 (e.g., network node 110 as described in connection with FIGS. 1-3, a CU, a DU, and/or an RU) may communicate with a UE 120 (e.g., UE 120 as described in connection with FIGS. 1-3). The network node 110 as described with reference to FIG. 6 may include a source network node as described in connection with FIGS. 4 and 7. In some aspects, the network node 110 and the UE 120 may be part of a wireless network (e.g., wireless network 100 as described in connection with FIGS. 1-3). The UE 120 and the network node as described in connection with FIGS. 1-3 may have established a wireless connection prior to operations shown in FIG. 6.

As shown by reference number 610, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC control elements (CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may enable the UE 120 to transmit an early CHO indication when performing a CHO procedure.

The UE 120 may configure itself based at least in part on the configuration information. In some aspects, the UE 120 may be configured to perform one or more operations described herein based at least in part on the configuration information.

As shown by reference number 620, the UE 120 may transmit, and the network node 110 may receive, a capabilities report. The capabilities report may indicate whether the UE 120 supports a feature and/or one or more parameters related to the feature. For example, the capability information may indicate a capability and/or parameter for communicating an early CHO indication and/or performing a CHO procedure. As another example, the capabilities report may indicate a capability and/or parameter for predicting one or more CHO execution parameters and/or one or more data forwarding parameters. One or more operations described herein may be based on capability information of the capabilities report. For example, the UE 120 may perform a communication in accordance with the capability information, or may receive configuration information that is in accordance with the capability information. In some aspects, the capabilities report may indicate that the UE 120 supports the prediction of some CHO execution parameters (e.g., and may indicate that the UE 120 is not supported to predict other CHO parameters) and/or some data forwarding parameters (e.g., and may indicate that the UE 120 is not supported to predict other data forwarding parameters). In some aspects, the capabilities report may indicate that the UE 120 supports early CHO indication and/or a CHO procedure according to a set of supported parameters. For example, the capabilities report may indicate that the UE 120 may support early CHO indication for a single target network node. In some other examples, the capabilities report may indicate that the UE 120 may support early CHO indication for multiple target network nodes.

In some aspects, the configuration information described in connection with reference number 610 and/or the capabilities report described in connection with reference number 620 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

As shown by reference number 630, in some examples, the network node 110 may transmit, and the UE 120 may receive, a CHO configuration. The CHO configuration may indicate one or more parameters for UE performance of a CHO procedure. For example, the UE 120 may transmit, and the network node 110 may receive, a CHO configuration including at least one CHO execution condition. The CHO execution condition may include at least one condition that is to be satisfied before the UE 120 may trigger the CHO procedure and switch from communicating with the network node 110 to communicating with a target network node.

In some aspects, the at least one CHO execution condition may include an RSRP threshold, an RSRQ threshold, a degradation threshold (e.g., a threshold measurement associated with a decline in channel quality), and/or a signal decibel level threshold. In some aspects, the CHO execution condition may include a timing threshold including a duration of time in which a signal quality associated with a target network node has been above a signal quality threshold before the CHO procedure may be initiated. In some aspects, the CHO execution condition may include a threshold quantity of communication bandwidth for communicating with the UE 120. In some aspects, the CHO execution condition may include a load balancing condition. For example, the UE 120 may perform CHO to a target network node associated with less traffic even when communications between the UE 120 and the network node 110 are within an acceptable signal quality range. In some aspects, the CHO execution condition may include a mobility pattern of the UE 120. For instance, the UE 120 may trigger the CHO procedure if the UE 120 is moving toward a target network node. In some aspects, the CHO execution condition may include a signal-to-interference-plus-noise ratio (SINR) threshold. In some aspects, the CHO execution condition may include a radio frequency condition associated with communications between the UE and the source network node. In some aspects, the CHO execution condition may include a UE transmission power threshold. In some aspects, the CHO execution condition may include a power headroom threshold, such as a power headroom threshold associated with a UE transmission power.

In some aspects, the CHO execution condition may include a confidence level condition. In some aspects, the CHO execution condition may include a confidence level threshold. In some aspects, the CHO execution condition may include an A3 event. For example, an A3 event may include the signal quality of a target cell improving beyond that of the serving cell by a margin (e.g., a hysteresis margin). In some aspects, the CHO execution condition may include an A4 event. For example, an A4 event may include the signal quality of a target cell exceeding a threshold. In some aspects, the CHO execution condition may include an A5 event. For example, an A5 event may include the signal quality of a target cell exceeding a threshold and a signal quality of the serving cell decreasing below a threshold level. In some aspects, the CHO execution condition may include an event trigger condition (e.g., an event other than A3, A4, and/or A5).

In some aspects, the CHO execution condition may include an absolute threshold. For example, the threshold may be relative to a fixed value. In some aspects, the CHO execution condition may include a relative threshold. For example, the threshold may be relative to a value associated with communications with the source network node and/or a target network node, in which case the condition is satisfied if a second value exceeds a first value by the threshold.

In some aspects, the CHO execution condition may include a time to trigger. For example, the CHO execution condition may include an amount of time that another condition continuously is met before the event is considered satisfied.

In some aspects, as shown by reference number 630, the network node 110 may transmit, and the UE 120 may receive, a CHO configuration including one or more of a set of one or more CHO execution conditions associated with a set of one or more candidate target network nodes, the set of one or more CHO execution conditions including the at least one CHO execution condition. For example, the CHO configuration may indicate a set of one or more CHO execution conditions including the at least one CHO execution condition, and/or may indicate one or more candidate target network nodes (e.g., with which the UE 120 may perform the CHO procedure). In some aspects, the CHO configuration may include a CHO configuration for performing a physical layer handover and/or a CHO configuration for performing a network layer handover. For example, a physical layer handover may refer to a Layer 1 CHO and may be performed via RRC signaling and/or may be an RRC signaling-based CHO procedure. In some aspects, a Layer 1 handover may be referred to as a lower layer triggered mobility (LTM) handover. For example, the CHO configuration may include a CHO configuration for a Layer 1 handover via MAC-CE signaling and/or physical PDCCH DCI signaling. In some aspects, a network layer handover may include a Layer 3 CHO and may be performed via MAC-CE signaling and/or may be a MAC-CE signaling-based CHO procedure. For example, the CHO configuration may include a CHO configuration for a Layer 3 handover via RRC signaling.

As shown by reference number 640, the network node 110 may transmit, and the UE 120 may receive, an early CHO indication configuration. For example, the network node 110 may transmit, and the UE 120 may receive, an early CHO indication configuration including a set of one or more early CHO indication activation parameters for transmitting an early CHO indication. In some aspects, the network node 110 may transmit, and the UE 120 may receive, an early CHO indication configuration including a set of one of more parameters for transmitting an early CHO indication. In some aspects, the set of one of more parameters for transmitting the early CHO indication may include a capability parameter of the source network node for early CHO data forwarding (e.g., a capability parameter of the network node 110 for performing data forwarding) in accordance with an early CHO indication procedure (e.g., including communicating the parameters for transmitting the early CHO indication, transmitting the early CHO indication, and/or the middle data forwarding), and/or an early CHO indication activation parameter. For example, the early CHO indication activation parameter may be associated with predicting that the at least one CHO execution condition will be satisfied and/or may include one or more other trigger conditions for transmitting an early CHO indication, such as the prediction of any CHO execution condition being satisfied. In some aspects, the capability parameter of the network node 110 may indicate whether the network node 110 supports data forwarding to a target network node during performance of the CHO procedure by the UE 120.

In some aspects, the set of one of more early CHO indication activation parameters may include one or more source cell radio frequency conditions, one or more serving cell radio link failure conditions, a serving cell reference signal received power threshold, a reference signal received quality threshold, a signal-to-noise ratio threshold, a source cell radio link failure timer status, a predicted time of radio link failure between the source network node and the UE, an energy mode of the source network node, one or more discontinuous reception parameters, one or more discontinuous transmission parameters, an activation parameter for network energy saving, and/or a deactivation parameter for network energy saving.

In some aspects, the set of early CHO indication activation parameters or the parameters for performing a CHO procedure may be defined as or may include one or more of: a reference signal received power (RSRP) threshold set, for example, within an exemplary range of −110 dBm to −70 dBm, with an operational value of −95 dBm for handover initiation in mid-band NR deployments; a signal-to-interference-plus-noise ratio (SINR) threshold selected within a range of −5 dB to 20 dB, with an exemplary value of 3 dB for reliable early CHO indication; a confidence level for AI/ML-based prediction of CHO execution set as a probability threshold (e.g., at least 85% predicted accuracy, or a confidence interval of ±5% around the predicted time of CHO execution) according to historical handover data; a predicted time window for CHO execution configured as an interval between 50 ms and 1000 ms prior to the anticipated satisfaction of the CHO execution condition, depending on UE velocity (e.g., 200 ms for stationary UEs, 800 ms for vehicular UEs). In some aspects, the early CHO indication may be transmitted via RRC signaling or via MAC-CE when at least one of these parameters or thresholds is anticipated to be met within the configured range. The set of parameters may, in some aspects, include an explicit candidate target cell identifier (e.g., PCI or gNB ID), a predicted execution timestamp, and an indication of the measured values (RSRP, SINR, RSRQ) at the time of prediction. These parameters may be stored and processed as part of the early CHO indication message, enabling the source network node to initiate middle data forwarding and resource preparation in line with the predicted CHO timeline.

In some aspects, the CHO configuration described in connection with reference number 630 and/or the early CHO indication configuration described in connection with reference number 640 may include information transmitted via multiple communications and/or via a single transmission. For example, the network node 110 may transmit, and the UE 120 may receive a first signal including the CHO configuration and/or the network node 110 may transmit, and the UE 120 may receive a second signal including the early CHO indication configuration. In some aspects, the first signal and the second signal are a same signal. In some aspects, the first signal is different from the second signal. In some aspects, one or more of the CHO configuration and/or the early CHO indication configuration are communicated via the configuration information described in connection with reference number 610. In some examples, the first signal and/or the second signal includes an RRC signal.

As described in connection with reference number 650, the UE 120 may predict the set of parameters for performing the CHO procedure. For example, the UE 120 may predict that the at least one CHO execution condition will be satisfied. In some aspects, the UE 120 may predict the set of parameters using an AI/ML module (e.g., as described in further detail with reference to FIG. 7). In some aspects, predicting the set of parameters for performing the CHO procedure may include obtaining a set of historical data associated with previous performances of CHO procedures (e.g., performed by the UE 120 and/or the network node 110). In such examples, the UE 120 may predict the set of parameters using the set of historical data.

As described in connection with reference number 660, the UE 120 may transmit, and the network node 110 may receive, an early CHO indication. For example, the UE 120 may transmit, and the network node 110 may receive, in accordance with the early CHO indication configuration, the early CHO indication prior to the at least one CHO execution condition being satisfied. In some aspects, the early CHO indication may include a set of parameters for middle data forwarding during a CHO procedure. In some aspects, transmitting the early CHO indication may be associated with predicting the set of parameters. For example, the UE 120 may predict that at least one CHO execution condition will be satisfied and/or may predict a time at which the at least one CHO execution condition will be satisfied. In some aspects, the UE 120 may predict a time and/or target network node for performing the CHO procedure in accordance with the prediction that the at least one CHO execution condition will be satisfied. In some aspects, transmitting the early CHO indication is associated with predicting that the at least one CHO execution condition will be satisfied, as described in connection with reference number 650.

In some aspects, transmitting the early CHO indication is associated with a radio frequency condition between the UE and the source network node satisfying at least one of the set of one or more early CHO indication activation parameters. For example, the UE 120 may identify or measure that one or more early CHO activation parameters satisfy a condition and may trigger the early CHO indication.

For example, the set of parameters for performing the CHO procedure may include at least one predicted target cell, and/or at least one predicted time, corresponding to the at least one predicted target cell, at which the CHO execution condition will be satisfied. In some aspects, the at least one predicted target cell and the at least one predicted time are associated with a data forwarding procedure. For example, the network node 110 may perform a data forwarding procedure with the at least one predicted target cell at the predicted time based on receiving the early CHO indication. As a result, the UE may select which target cell to which it will be handed over based on one or more predictions of a future time at which a connection with the source network node will be degraded. For example, the UE 120 may identify one or more target cells with a same or predicted CHO time (e.g., a time at which the CHO conditions will be met) in the future, and may indicate this to the network node.

In some aspects, the set of one or more parameters for performing the CHO procedure may include a duration for performing the CHO procedure, one or more target network nodes, one or more times for performing the CHO procedure corresponding to the one or more target network nodes and/or a time for performing data forwarding by the source network node. For example, the set of parameters may include a first time at which the UE 120 may perform a CHO procedure with a first target network node, through an n^{th} time at which the UE 120 may perform a CHO procedure with an n^{th} target network node.

In some aspects, the set of one or more parameters for performing the CHO procedure may include a predicted starting time for performing the CHO procedure. For example, the predicted starting time may indicate a time at which the UE 120 is predicted to execute the CHO procedure triggered by an execution condition. The predicted starting time may be based on the predicted execution condition and/or the prediction that the execution condition will be satisfied. For example, the predicted starting time may be after a predicted time at which the predicted execution condition will be satisfied.

In some aspects, the set of one or more parameters for performing the CHO procedure may include a duration for performing the CHO procedure. For example, the duration may indicate a span of time in which the UE 120 performs the CHO procedure. For example, the duration may indicate a length in time of the CHO procedure spanning from execution of the CHO procedure to completion of the CHO procedure.

In some aspects, the set of one or more parameters for performing the CHO procedure may include one or more target network nodes for performing the CHO procedure. For example, the one or more target network nodes may be associated with the one or more predicted execution conditions. In some aspects, the predicted execution condition is associated with a target network node (e.g., for performing CHO). In some aspects, the set of one or more parameters for performing the CHO procedure may include multiple target nodes, each corresponding to a predicted execution condition.

In some aspects, the set of one or more parameters for performing the CHO procedure may include one or more respective starting times for performing the CHO procedure corresponding to the one or more target network nodes. For example, each of the one or more target nodes may be associated with a different starting time based on the corresponding predicted execution condition.

In some aspects, the set of one or more parameters for performing the CHO procedure may include a predicted time for the source network node to perform a data forwarding procedure. In some aspects, the set of one or more parameters for performing the CHO procedure may include a predicted time window for the source network node to perform a data forwarding procedure.

As described in connection with reference number 670, the UE 120 may identify that the at least one CHO execution condition (e.g., described in connection with reference number 630) is satisfied.

As described in connection with reference number 680, the UE 120 may initiate the CHO procedure, with one or more target network nodes, according to the set of parameters for performing the CHO procedure (e.g., as described in connection with reference number 660). For example, the UE 120 may initiate the CHO procedure based on identifying that the at least one CHO execution condition is satisfied. The UE 120 and/or the network node 110 may perform one or more aspects of the CHO procedure as described with reference to FIGS. 4 and/or 7. In some aspects, performing the CHO procedure with the network node 110 may cause the UE 120 to cease communications with the network node 110. For example, the UE 120 may cease communication with the network node 110 in accordance with identifying that the at least one CHO execution condition is satisfied.

As described in connection with reference number 690, the network node 110 may perform data forwarding. For example, the network node 110 may forward, to one or more target network nodes of the UE 120 (e.g., indicated in the CHO configuration described in connection with reference number 630), a set of one or more data packets for the UE 120 according to the set of predicted parameters for performing the CHO procedure (e.g., as described in connection with reference numbers 650 & 660). For example, because the UE 120 has ceased communication with the network node 110, the network node 110 may forward data intended for the UE 120 at the time for performing the CHO procedure associated with the target network node, as indicated by the early CHO indication. As a result, the network node 110 may perform data forwarding without additional indication from the UE 120 that the CHO is being performed.

In some aspects, the network node 110 may forward, to one or more target network nodes of the UE 120 (e.g., a predicted target network node, a target network node indicated by the early CHO indication), a set of one or more data packets for the UE according to the set of parameters indicated by the early CHO indication.

In some aspects, the network node 110 may perform the data forwarding according to the set of parameters indicated by the early CHO indication, the set of parameters including the predicted CHO execution starting time and/or the predicted CHO execution starting time window. In such examples, the network node 110 may forward, to one or more target network nodes indicated by the early CHO indication, a set of one or more data packets for the UE 120. In some aspects, the one or more target network nodes may include one or more predicted target network nodes indicated by the early CHO indication.

In some aspects, the network node 110 may perform the data forwarding at a time indicated by the set of parameters indicated by the early CHO indication. In some aspects, the time may include a predicted time indicated by the early CHO indication.

In some aspects, the example 600 may be an example of a CHO procedure in accordance with the transmission of an early CHO indication. Such CHO procedures may be referred to as an enhanced CHO procedure due to the decreased latency associated with early CHO indication and increased reliability of communications associated with mid-CHO data forwarding. In some aspects, such CHO procedures may additionally or alternatively be referred to as an early CHO indication-based CHO procedure because the CHO procedure may be based on or otherwise associated with the transmission of an early CHO indication.

As indicated above, FIG. 6 is provided as an example. Other examples may differ from what is described with respect to FIG. 6.

FIG. 7 is a diagram illustrating an example 700 of transmitting an early CHO indication, in accordance with the present disclosure. A source network entity, such as gNB 705 (e.g., base station 110), may provide a source cell for a UE (e.g., UE 120). The UE 120 may be handed over from the source cell to a candidate target cell provided by either candidate target gNB 710 (e.g., a base station 110) or candidate target gNB 715 (e.g., a base station 110). Each of the gNBs may be connected to a 5G core network (5GC 720). The example 700 may illustrate a CHO procedure that is associated with early CHO indication. For example, the CHO procedure illustrated in FIG. 7 may be more efficient, incur less overhead, and/or reduce latency, among other examples, when compared to other CHO procedures in which early CHO indication is not enabled.

CHO may include several phases. The phases may include an handover preparation phase, a handover execution phase, and a handover completion phase. In some aspects, the UE 120 may make and report measurements during the handover preparation phase. There may be multiple candidate target cells, such as target cells provided by target gNB 710 and target gNB 715. Selection to a particular target cell, such as the target cell provided by target gNB 715, may be based on meeting a condition of the particular target cell. During the handover execution phase, the UE 120 may execute the handover by performing a random access channel (RACH) procedure with the target gNB 715 and establishing a radio resource control (RRC) connection with the target gNB 715. During the handover completion phase, the source gNB 705 may forward stored communications associated with the UE 120 to the target gNB 715, and the UE 120 may be released from the source connection to the source gNB 705.

CHO may involve multiple steps in each of the handover phases. As shown by reference number 722, the UE 120 may determine that an event trigger or handover condition is being met. The UE 120 may perform measurements (such as on signals of the source cell or neighboring cells) and transmit a measurement report to the source gNB 705 of the source cell, as shown by reference number 724. The measurement report may indicate, for example, an RSRP parameter, an RSRQ parameter, an RSSI parameter, or a signal-to-interference-plus-noise ratio (SINR) parameter.

As shown by reference number 726, the source gNB 705 and each candidate target gNB of the candidate target cells may prepare for a handover. As shown by reference number 728, the source gNB 705 may transmit an RRC reconfiguration message to the UE 120. The RRC reconfiguration message may include a handover command instructing the UE 120 to execute the CHO from the source gNB 705 to one of the candidate target gNBs. The handover command may include information associated with each candidate target gNB, including a condition (e.g., threshold) for a handover to a particular candidate target gNB, such as target gNB 710 or target gNB 715. The UE 120 may simultaneously maintain the source connection to the source gNB 705 and a target connection to the target gNB 710 or target gNB 715.

As shown by reference number 730, the source gNB 705 may start forwarding user data while the target cell is prepared (referred to as “early forwarding”). When the CHO is executed successfully, the source gNB 705 may also forward data (referred to as “late forwarding”). In some cases, a gNB may implement late forwarding, since early forwarding could be wasteful if the CHO is never executed. On the other hand, there is potential data lost with late forwarding, since after the time the UE 120 leaves the source gNB 705 and the CHO is completed, the source gNB 705 will continue transmitting data to the UE 120 which will not be received, and such data either will need to be recovered by retransmission or will be lost completely.

In some aspects, the RRC reconfiguration message may include a candidate target cell configuration and CHO execution conditions by which the UE 120 is to prepare for a CHO. The execution conditions may include an A3 conditional event, where measurements for a candidate target cell become better by a first threshold amount (e.g., specified offset of 3 decibels (dB)) than measurements for a current cell (PCell or PSCell). The execution conditions may include an A5 event, where the measurements at the current cell become worse by a second threshold amount (e.g., offset in dB) and the measurements for the candidate target cell become better than a third threshold amount (e.g., absolute amount in dB). The UE 120 may monitor for conditional events such as A3 and A5 during a time to trigger (TTT) period, which may involve a TTT timer.

An RRC container may carry a candidate target cell configuration, and the source gNB 705 may not be allowed to alter any content of the candidate target cell configuration. Multiple candidate target cells (e.g., up to 8) may be configured. These may include delta configurations, which may be configurations that provide only a difference between a candidate target cell configuration and a configuration of the source gNB 705. The source gNB 705 may coordinate with a target gNB when there are any source or target changes and may update the UE 120. As shown by reference number 732, the UE 120 may verify the validity of the configuration of the source gNB 705 configuration upon reception. The CHO execution condition configuration may specify that the CHO entry condition is to be satisfied before the TTT ends (e.g., with an exit condition). A CHO execution condition configuration may include triggering quantities of RSRP, RSRP, and SINR that are configured simultaneously. There may be a single reference signal type, such as a synchronization signal block (SSB) or a channel state information reference signal (CSI-RS), per CHO candidate target cell.

If reconfiguration with synchronization (with or without key change) happens before CHO execution conditions are met, the UE 120 may delete stored CHO configurations. When a radio link failure occurs, if a selected target cell is a CHO candidate target cell, the UE 120 may perform CHO completion. If not, legacy reestablishment may be performed. As shown by reference number 734, UE 120 may be transmitting user data to and receiving user data from the source gNB 705, which communicates the user data with the 5GC 720.

As shown by reference number 736, the UE 120 may transmit an RRC reconfiguration complete message to the source gNB.

As shown by reference number 740, the UE 120 may transmit, and the source gNB 705 may receive, an early CHO indication. For example, the UE 120 may predict one or more conditions associated with executing a CHO procedure and may transmit an early CHO indication prior to a CHO trigger condition being satisfied. In some examples, the UE 120 may predict the one or more conditions associated with executing the CHO procedure using an AI/ML model.

AI/ML involves computers learning from data to perform tasks. AI/ML algorithms are used to train AI/ML models based on sample data, known as “training data.” Once trained, AI/ML models may be used to make predictions, decisions, or classifications relating to new observations. AI/ML algorithms may be used to train AI/ML models for a wide variety of applications, including computer vision, natural language processing, financial applications, medical diagnosis, and/or information retrieval, among many other examples.

Vast amounts of data may be stored electronically in data structures (e.g., databases, blockchains, log files, cookies, or the like). A device may perform multiple queries, or other information retrieval techniques, to unrelated data structures to obtain data relevant to a particular task or computational operation. Moreover, each data structure may employ a particular schema and/or use particular data formatting conventions for data storage. Thus, the data may be incompatible and difficult to integrate into machine-usable outputs for computational instructions or automation. This incompatibility may necessitate separate handling of the data using complex instructions and/or repetitive processing to achieve desired computational outcomes or automation outcomes, thereby expending significant computing resources (e.g., processor resources and/or memory resources) and causing significant delays.

In addition, separate use of the data, such as individually presenting the data in a user interface for analysis by a user, may be inefficient. For example, the device may separately process and/or reformat data from different data structures to obtain information for presenting in the user interface, thereby expending significant computing resources. Furthermore, individually presenting the data may increase the size of a user interface (e.g., a web page) or utilize multiple user interfaces (e.g., multiple web pages). Navigating through a large user interface or a large number of user interfaces to find relevant information creates a poor user experience, consumes excessive computing resources that are needed for a client device to generate and display the user interface(s) and that are needed for one or more server devices to serve the user interface(s) to the client device, and consumes excessive network resources that are needed for communications between the client device and the server device.

Some implementations described herein enable integration of otherwise incompatible data from multiple unrelated data structures. In some implementations, a system may use an AI/ML model to predict one or more conditions for triggering a CHO procedure being satisfied and/or one or more parameters associated with performing the CHO procedure, such as a time for performing the CHO procedure and/or a target network node. For example, the AI/ML model may determine a most suitable target network node with which to perform handover based on data relating to previous CHO procedures associated with the UE 120, the source gNB 705, target gNBs 710 and 715 and/or performance of a CHO procedure by one or more other UEs and/or network nodes.

In this way, the AI/ML model enables the system to perform operations based on otherwise incompatible data while conserving computing resources and reducing delays that would otherwise result from separate handling of the data using complex instructions and/or repetitive processing. Moreover, an output of the AI/ML model may convey data from the multiple unrelated databases in a smaller user interface or in a lesser number of user interfaces than otherwise would have been used to individually present data from the multiple unrelated databases. In this way, the use of computing resources and network resources is reduced in connection with serving, generating, and/or displaying the user interface(s).

As shown by reference number 742, the UE 120 may determine that an event is triggered for handover to the target cell for the target gNB 715. As shown by reference number 744, the UE 120 may verify a configuration of the target gNB 715. Verification may take place at an earlier time. As shown by reference number 746, the UE 120 may release the source connection to the source cell and execute the CHO to the target gNB 715.

As shown by reference number 748, the source gNB 705 may perform data forwarding to the target gNB 715 according to one or more parameters indicated by the early CHO indication. In some aspects, the source gNB 705 may perform data forwarding to the target gNB 715 during the CHO execution. In some aspects, forwarding data to a target gNB 715 during execution of a CHO procedure and/or in response to an early CHO indication may be referred to as middle data forwarding, mid-data forwarding, intermedial data forwarding, intermediate data forwarding, and/or any other similar term meaning a data forwarding procedure that occurs after “early data forwarding” to the core network and before “later data forwarding.”

As shown by reference number 750, the UE 120 may connect to the target gNB 715 as part of the handover execution phase. The UE 120 may connect to the target gNB 715 by performing a RACH procedure with the target gNB 715. Upon successfully establishing a connection with the target gNB 715, the UE 120 may transmit an RRC reconfiguration complete message to the target gNB 715, as shown by reference number 752. A difference between CHO and legacy handover is that the UE 120 does not need to send the measurement report to the source gNB 705 and wait for a handover command. This makes the CHO more robust for cases when the source cell conditions degrade rapidly. In addition, CHO improves the handover latency by eliminating reporting and handover command reception.

As shown by reference number 754, the target gNB 715 may transmit a handover connection setup complete message (e.g., HOSuccess) to the source gNB 705. Reception of the handover connection setup complete message from the target gNB 715 may trigger the source gNB 705 to stop transmitting data to the UE 120 or to stop receiving data from the UE 120.

When the CHO execution condition is met for a candidate target cell, a timer may be used for CHO completion. The UE 120 does not monitor source cell transmissions afterwards and does not receive new RRC messages. The UE 120 stops transmissions to the source cell. The UE 120 may transmit a handover complete message to the target cell, as in legacy handover. The UE 120 may stop evaluating the triggering condition of other candidate cells during CHO execution (may still perform measurements on them).

As shown by reference number 756, the source gNB 705 may perform later data forwarding. For example, the gNB 705 may forward communications associated with the UE 120 to the target gNB 715 or to notify the target gNB 715 of a status of one or more communications with the UE 120. The source gNB 705 may notify the target gNB 715 regarding a packet data convergence protocol (PDCP) status associated with the UE 120 or a serial number to be used for a downlink communication with the UE 120.

If CHO completion fails (e.g., the timer expires), the UE 120 may perform cell selection using a legacy procedure. If the selected cell is a CHO candidate, the UE 120 may attempt to complete CHO to the selected cell. This is an optional UE capability. Otherwise, the UE 120 follows legacy reestablishment. As shown by reference number 758, the source gNB 705 may transmit a handover cancel message to any candidate target gNBs that the UE 120 did not select for handover. For example, the source gNB 705 may transmit a handover cancel message to the target gNB 710.

The target gNB 715 may communicate with the 5GC 720 to switch a user plane path of the UE 120 from the source gNB 705 to the target gNB 715, as shown by reference number 760. Prior to switching the user plane path, downlink communications for the UE 120 may be routed through the 5GC 720 to the source gNB 705. After the user plane path is switched, downlink communications for the UE 120 may be routed through the 5GC 720 to the target gNB 715. As shown by reference number 762, the source gNB 705 may release a UE context for the UE 120.

In dual connectivity scenarios, a secondary node (SN) of a cell may be used with a primary node of a cell to increase a bandwidth or a performance for a UE. Traffic on the primary node and the SN may be aggregated. In such a scenario, the UE 120 may change SNs. This may be referred to as conditional “primary secondary cell (PSCell) change” for NR. In some aspects, the change may be performed with operations comparable to a DAPS handover, a CHO, or another type of handover. The UE may decide to change from the source secondary cell (SCell) to a target SCell. The UE may decide this change based on, for example, measurements from the source SCell or the target SCell.

The CHO may include a DAPS handover from the source gNB 705 to the target gNB 715. The UE 120 may connect to the target gNB 715 as part of the handover execution phase and transmit uplink data, uplink control information, or an uplink reference signal (such as a sounding reference signal) to the source gNB 705, or may receive downlink data, downlink control information, or a downlink reference signal from the source gNB 705. While the UE 120 is performing the RACH procedure with the target gNB 715, the UE 120 may transmit uplink data, uplink control information, or an uplink reference signal (such as a sounding reference signal) to the source gNB 705, or may receive downlink data, downlink control information, or a downlink reference signal from the source gNB 705. Because the DAPS handover may be a make before break (MBB) handover, the UE 120 may simultaneously maintain the source connection with the source gNB 705 and the target connection with the target gNB 715.

The UE 120 may initiate the CHO procedure based on a handover condition being satisfied, which may be at the certain (earlier) point of the TTT timer. This may involve another timer that is started when the event entering condition is satisfied. The handover condition may include a threshold gradient of signal strength, a threshold gradient of signal quality, a threshold Doppler parameter, or a threshold velocity of the UE 120. The handover condition may be satisfied, for example, when a measured gradient of signal strength meets or exceeds a gradient threshold of signal strength, when a measured gradient of signal quality meets or exceeds a gradient threshold of signal quality, when a Doppler parameter meets a Doppler parameter threshold, or when a velocity of the UE 120 meets or exceeds a velocity threshold. The handover condition may include other aspects of UE mobility and signal characteristics.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with an early conditional handover procedure.

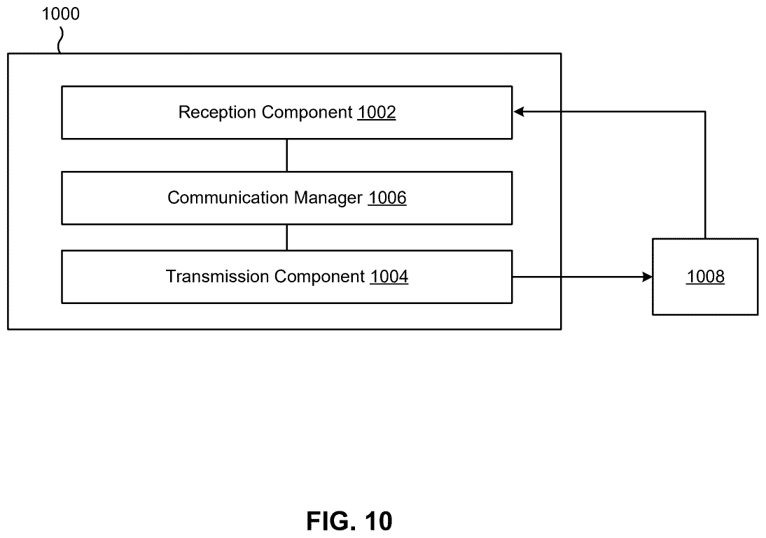

As shown in FIG. 8, in some aspects, process 800 may include receiving an early CHO indication configuration including a set of one or more early CHO indication activation parameters for transmitting an early CHO indication (block 810). For example, the UE (e.g., using reception component 1002 and/or communication manager 1006, depicted in FIG. 10) may receive an early CHO indication configuration including a set of one or more early CHO indication activation parameters for transmitting an early CHO indication, as described above.

As further shown in FIG. 8, in some aspects, process 800 may include transmitting, to a source network node in accordance with the early CHO indication configuration, the early CHO indication prior to at least one CHO execution condition being satisfied, the early CHO indication including a set of parameters for middle data forwarding during a CHO procedure (block 820). For example, the UE (e.g., using transmission component 1004 and/or communication manager 1006, depicted in FIG. 10) may transmit, to a source network node in accordance with the early CHO indication configuration, the early CHO indication prior to at least one CHO execution condition being satisfied, the early CHO indication including a set of parameters for middle data forwarding during a CHO procedure, as described above.

Process 800 may include additional aspects, such as any single aspect or any combination of aspects described below and/or in connection with one or more other processes described elsewhere herein.
In a first aspect, the set of parameters for performing the CHO procedure includes one or more predicted target cells, and at least one of a predicted time or a predicted time window, corresponding to at least one of the one or more predicted target cells, during which the CHO execution condition will be satisfied.
In a second aspect, alone or in combination with the first aspect, the one or more predicted target cells and at least one of the predicted time or the predicted time window are associated with a data forwarding procedure.
In a third aspect, alone or in combination with one or more of the first and second aspects, the data forwarding procedure includes at least one of a mid-CHO data forwarding procedure, a mid-forwarding procedure, a middle data forwarding procedure, or an intermediate data forwarding procedure.
In a fourth aspect, alone or in combination with one or more of the first through third aspects, the data forwarding procedure is an intermediary data forwarding procedure relative to an early data forwarding procedure and a later data forwarding procedure, the early data forwarding procedure occurring during an initial portion of the CHO procedure and the later data forwarding procedure occurring during a final portion of the CHO procedure.
In a fifth aspect, alone or in combination with one or more of the first through fourth aspects, the CHO procedure is associated with the early CHO indication.
In a sixth aspect, alone or in combination with one or more of the first through fifth aspects, process 800 includes predicting the set of parameters for performing the CHO procedure.
In a seventh aspect, alone or in combination with one or more of the first through sixth aspects, predicting the set of parameters for performing the CHO procedure, as part of the process 800, comprises predicting the set of parameters using an artificial intelligence (AI) or machine learning (ML) (AI/ML) module.
In an eighth aspect, alone or in combination with one or more of the first through seventh aspects, predicting the set of parameters for performing the CHO procedure, as part of the process 800, comprises obtaining a set of historical data associated with previous performances of CHO procedures, and predicting the set of parameters for performing the CHO procedure using the set of historical data.
In a ninth aspect, alone or in combination with one or more of the first through eighth aspects, transmitting the early CHO indication is associated with predicting the set of parameters.
In a tenth aspect, alone or in combination with one or more of the first through ninth aspects, the set of parameters for performing the CHO procedure comprises one or more of a predicted time at which the at least one CHO execution condition will trigger the CHO procedure, a predicted duration in which the at least one CHO execution condition will be continuously satisfied, one or more candidate target network nodes, one or more respective starting times for performing the CHO procedure corresponding to the one or more candidate target network nodes, or a predicted time for the source network node to perform a data forwarding procedure, or a predicted time window for the source network node to perform a data forwarding procedure.
In an eleventh aspect, alone or in combination with one or more of the first through tenth aspects, process 800 includes predicting that the at least one CHO execution condition will be satisfied, wherein transmitting the early CHO indication is associated with predicting that the at least one CHO execution condition will be satisfied.
In a twelfth aspect, alone or in combination with one or more of the first through eleventh aspects, the at least one CHO execution condition comprises one or more of a reference signal received power threshold, a reference signal received quality threshold, a signal-to-interference noise ratio threshold, a radio frequency condition associated with communications between the UE and the source network node, a UE transmission power threshold, a power headroom threshold associated with a UE transmission power, a power headroom threshold, a confidence level condition, a confidence level threshold, an A3 event, an A4 event, an A5 event, an event trigger condition, an absolute threshold, a relative threshold, or a time to trigger.
In a thirteenth aspect, alone or in combination with one or more of the first through twelfth aspects, process 800 includes receiving at least one of a CHO configuration for a Layer 1 handover via at least one of medium access control (MAC) control element (CE) (MAC-CE) signaling or physical downlink control channel (PDCCH) downlink control information (DCI) signaling, or a CHO configuration for a Layer 3 handover via radio resource control (RRC) signaling.
In a fourteenth aspect, alone or in combination with one or more of the first through thirteenth aspects, receiving the early CHO indication configuration, as part of the process 800, comprises receiving first signaling including the early CHO indication configuration, the method further comprising receiving second signaling including at least one of a Layer 1 CHO configuration or a Layer 3 CHO configuration.
In a fifteenth aspect, alone or in combination with one or more of the first through fourteenth aspects, the first signaling and the second signaling are a same signaling.
In a sixteenth aspect, alone or in combination with one or more of the first through fifteenth aspects, the first signaling is different from the second signaling.
In a seventeenth aspect, alone or in combination with one or more of the first through sixteenth aspects, at least one of the first signaling or the second signaling includes radio resource control signaling.
In an eighteenth aspect, alone or in combination with one or more of the first through seventeenth aspects, the early CHO indication configuration includes one or more of a capability parameter of the source network node for performing data forwarding in accordance with an early CHO indication procedure.
In a nineteenth aspect, alone or in combination with one or more of the first through eighteenth aspects, the early CHO indication configuration includes a set of parameters for performing an early CHO indication procedure, and the set of parameters for performing the early CHO indication procedure includes the set of one or more early CHO indication activation parameters.
In a twentieth aspect, alone or in combination with one or more of the first through nineteenth aspects, the set of one or more early CHO indication activation parameters includes at least one of one or more source cell radio frequency conditions, one or more serving cell radio link failure conditions, a serving cell reference signal received power threshold, a reference signal received quality threshold, a signal-to-noise ratio threshold, a source cell radio link failure timer status, a predicted time of radio link failure between the source network node and the UE, an energy mode of the source network node, one or more discontinuous reception parameters, one or more discontinuous transmission parameters, an activation parameter for network energy saving, or a deactivation parameter for network energy saving.
In a twenty-first aspect, alone or in combination with one or more of the first through twentieth aspects, transmitting the early CHO indication is associated with a radio frequency condition between the UE and the source network node satisfying at least one of the set of one or more early CHO indication activation parameters.
In a twenty-second aspect, alone or in combination with one or more of the first through twenty-first aspects, the CHO procedure comprises at least one of an early CHO indication-based CHO procedure or an enhanced CHO procedure.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with an early conditional handover procedure.

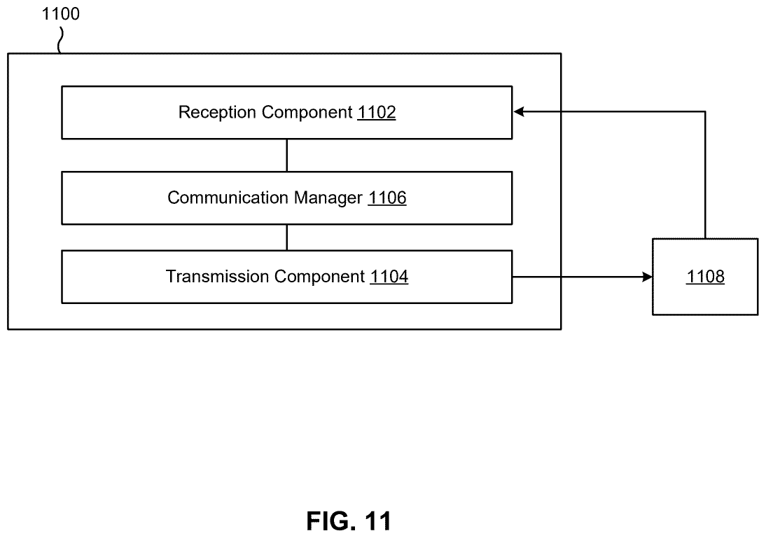

As shown in FIG. 9, in some aspects, process 900 may include transmitting an early CHO indication configuration including a set of one or more early CHO indication activation parameters for communicating an early CHO indication (block 910). For example, the network node (e.g., using transmission component 1104 and/or communication manager 1106, depicted in FIG. 11) may transmit an early CHO indication configuration including a set of one or more early CHO indication activation parameters for communicating an early CHO indication, as described above.

As further shown in FIG. 9, in some aspects, process 900 may include receiving, from a UE in accordance with the early CHO indication configuration, the early CHO indication prior to at least one CHO execution condition being satisfied, the early CHO indication including a set of parameters for performing middle data forwarding during a CHO procedure (block 920). For example, the network node (e.g., using reception component 1102 and/or communication manager 1106, depicted in FIG. 11) may receive, from a UE in accordance with the early CHO indication configuration, the early CHO indication prior to at least one CHO execution condition being satisfied, the early CHO indication including a set of parameters for performing middle data forwarding during a CHO procedure, as described above.

Process 900 may include additional aspects, such as any single aspect or any combination of aspects described below and/or in connection with one or more other processes described elsewhere herein.
In a first aspect, performing the data forwarding during the CHO procedure, as part of the process 900, comprises forwarding, to one or more target network nodes of the UE, a set of one or more data packets for the UE according to the set of parameters indicated by the early CHO indication.
In a second aspect, alone or in combination with the first aspect, process 900 includes performing the data forwarding according to the set of parameters indicated by the early CHO indication, the set of parameters including at least one of a predicted CHO execution starting time or a predicted CHO execution starting time window.
In a third aspect, alone or in combination with one or more of the first and second aspects, performing the data forwarding, as part of the process 900, comprises forwarding, to one or more target network nodes indicated by the early CHO indication, a set of one or more data packets for the UE.
In a fourth aspect, alone or in combination with one or more of the first through third aspects, the one or more target network nodes include one or more predicted target network nodes indicated by the early CHO indication.
In a fifth aspect, alone or in combination with one or more of the first through fourth aspects, performing the data forwarding, as part of the process 900, comprises performing the data forwarding at a time indicated by the set of parameters indicated by the early CHO indication.
In a sixth aspect, alone or in combination with one or more of the first through fifth aspects, the time includes a predicted time indicated by the early CHO indication.
In a seventh aspect, alone or in combination with one or more of the first through sixth aspects, the set of parameters for performing the data forwarding during the CHO procedure includes one or more predicted target cells, and at least one of a predicted time or a predicted time window, corresponding to at least one of the one or more predicted target cells, during which the CHO execution condition will be satisfied.
In an eighth aspect, alone or in combination with one or more of the first through seventh aspects, the at least one predicted target cell and the at least one predicted time are associated with the data forwarding.
In a ninth aspect, alone or in combination with one or more of the first through eighth aspects, the data forwarding includes at least one of a mid-CHO data forwarding procedure, a mid-forwarding procedure, a middle data forwarding procedure, or an intermediate data forwarding procedure.
In a tenth aspect, alone or in combination with one or more of the first through ninth aspects, the CHO procedure is associated with the early CHO indication.
In an eleventh aspect, alone or in combination with one or more of the first through tenth aspects, the data forwarding includes an intermediary data forwarding procedure relative to an early data forwarding procedure and a later data forwarding procedure, the early data forwarding procedure occurring during an initial portion of the CHO procedure and the later data forwarding procedure occurring during a final portion of the CHO procedure.
In a twelfth aspect, alone or in combination with one or more of the first through eleventh aspects, the set of parameters for performing the data forwarding during the CHO procedure comprise a set of predicted parameters.
In a thirteenth aspect, alone or in combination with one or more of the first through twelfth aspects, the set of parameters for performing the CHO procedure comprises one or more of a predicted time at which the at least one CHO execution condition will trigger the CHO procedure, a predicted duration in which the at least one CHO execution condition will be continuously satisfied, one or more candidate target network nodes, one or more respective starting times for the CHO procedure corresponding to the one or more candidate target network nodes, or a predicted time for the data forwarding, or a predicted time window for the data forwarding.
In a fourteenth aspect, alone or in combination with one or more of the first through thirteenth aspects, receiving the early CHO indication is associated with a prediction that the at least one CHO execution condition will be satisfied.
In a fifteenth aspect, alone or in combination with one or more of the first through fourteenth aspects, the at least one CHO execution condition comprises one or more of a reference signal received power threshold, a reference signal received quality threshold, a signal-to-interference noise ratio threshold, a radio frequency condition associated with communications between the UE and the network node, a UE transmission power threshold, a power headroom threshold associated with a UE transmission power, a power headroom threshold, a confidence level condition, a confidence level threshold, an A3 event, an A4 event, an A5 event, an event trigger condition, an absolute threshold, a relative threshold, or a time to trigger.
In a sixteenth aspect, alone or in combination with one or more of the first through fifteenth aspects, process 900 includes transmitting at least one of a CHO configuration for a Layer 1 handover via at least one of medium access control (MAC) control element (CE) (MAC-CE) signaling or physical downlink control channel (PDCCH) downlink control information (DCI) signaling, or a CHO configuration for a Layer 3 handover via radio resource control (RRC) signaling.
In a seventeenth aspect, alone or in combination with one or more of the first through sixteenth aspects, transmitting the early CHO indication configuration comprises transmitting first signaling including the early CHO indication configuration, the method further comprising transmitting second signaling including at least one of a Layer 1 CHO configuration or a Layer 3 CHO configuration.
In an eighteenth aspect, alone or in combination with one or more of the first through seventeenth aspects, the first signaling and the second signaling are a same signaling.
In a nineteenth aspect, alone or in combination with one or more of the first through eighteenth aspects, the first signaling is different from the second signaling.
In a twentieth aspect, alone or in combination with one or more of the first through nineteenth aspects, at least one of the first signaling or the second signaling includes radio resource control signaling.
In a twenty-first aspect, alone or in combination with one or more of the first through twentieth aspects, process 900 includes transmitting a CHO configuration including one or more of a set of one or more CHO execution conditions associated with a set of one or more candidate target network nodes, the set of one or more CHO execution conditions including the at least one CHO execution condition.
In a twenty-second aspect, alone or in combination with one or more of the first through twenty-first aspects, the CHO configuration indicates the set of one or more candidate target network nodes.
In a twenty-third aspect, alone or in combination with one or more of the first through twenty-second aspects, the early CHO indication configuration includes one or more of a capability parameter of the network node for performing the data forwarding in accordance with an early CHO indication procedure.
In a twenty-fourth aspect, alone or in combination with one or more of the first through twenty-third aspects, the early CHO indication configuration includes a set of parameters for performing an early CHO indication procedure, and the set of parameters for performing the early CHO indication procedure includes the set of one or more early CHO indication activation parameters.
In a twenty-fifth aspect, alone or in combination with one or more of the first through twenty-fourth aspects, the set of one or more early CHO indication activation parameters includes at least one of one or more source cell radio frequency conditions, one or more serving cell radio link failure conditions, a serving cell reference signal received power threshold, a reference signal received quality threshold, a signal-to-noise ratio threshold, a source cell radio link failure timer status, a predicted time of radio link failure between the network node and the UE, an energy mode of the network node, one or more discontinuous reception parameters, one or more discontinuous transmission parameters, an activation parameter for network energy saving, or a deactivation parameter for network energy saving.
In a twenty-sixth aspect, alone or in combination with one or more of the first through twenty-fifth aspects, receiving the early CHO indication is associated with a radio frequency condition between the UE and the network node satisfying at least one of the set of one or more early CHO indication activation parameters.
In a twenty-seventh aspect, alone or in combination with one or more of the first through twenty-sixth aspects, the CHO procedure comprises at least one of an early CHO indication-based CHO procedure or an enhanced CHO procedure.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1 and FIG. 2. Additionally, or alternatively, one or more components shown in FIG. 10 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive an early CHO indication configuration including a set of one or more early CHO indication activation parameters for transmitting an early CHO indication. The transmission component 1004 may transmit, to a source network node in accordance with the early CHO indication configuration, the early CHO indication prior to at least one CHO execution condition being satisfied, the early CHO indication including a set of parameters for middle data forwarding during a CHO procedure.

The communication manager 1006 may predict the set of parameters for performing the CHO procedure. The communication manager 1006 may predict the set of parameters using an AI/ML module. The communication manager 1006 may obtain a set of historical data associated with previous performances of CHO procedures. The communication manager 1006 may predict the set of parameters for performing the CHO procedure using the set of historical data.

The communication manager 1006 may predict that the at least one CHO execution condition will be satisfied, wherein transmitting the early CHO indication is associated with predicting that the at least one CHO execution condition will be satisfied.

The reception component 1002 may receive at least one of a CHO configuration for a Layer 1 handover via at least one of MAC-CE signaling or PDCCH DCI signaling, or a CHO configuration for a Layer 3 handover via radio resource control (RRC) signaling. The reception component 1002 may receive second signaling including at least one of a Layer 1 CHO configuration or a Layer 3 CHO configuration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-7. Additionally, or alternatively, the apparatus 1100 may be configured to perform one or more processes described herein, such as process 9 of FIG. 9, or a combination thereof. In some aspects, the apparatus 1100 and/or one or more components shown in FIG. 11 may include one or more components of the network node described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit an early CHO indication configuration including a set of one or more early CHO indication activation parameters for communicating an early CHO indication. The reception component 1102 may receive, from a UE in accordance with the early CHO indication configuration, the early CHO indication prior to at least one CHO execution condition being satisfied, the early CHO indication including a set of parameters for performing middle data forwarding during a CHO procedure.

Th e communication manager 1106 may forward, to one or more target network nodes of the UE, a set of one or more data packets for the UE according to the set of parameters indicated by the early CHO indication.

The communication manager 1106 may perform the data forwarding according to the set of parameters indicated by the early CHO indication, the set of parameters including at least one of a predicted CHO execution starting time or a predicted CHO execution starting time window.

The communication manager 1106 may forward, to one or more target network nodes indicated by the early CHO indication, a set of one or more data packets for the UE. The communication manager 1106 may forward the data forwarding at a time indicated by the set of parameters indicated by the early CHO indication.

The transmission component 1104 may transmit at least one of a CHO configuration for a Layer 1 handover via at least one of MAC-CE signaling or PDCCH DCI signaling, or a CHO configuration for a Layer 3 handover via RRC signaling. The transmission component 1104 may transmit second signaling including at least one of a Layer 1 CHO configuration or a Layer 3 CHO configuration The transmission component 1104 may transmit a CHO configuration including one or more of a set of one or more CHO execution conditions associated with a set of one or more candidate target network nodes, the set of one or more CHO execution conditions including the at least one CHO execution condition.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

### Aspect 1

A method of wireless communication performed by a user equipment (UE), comprising: receiving an early conditional handover (CHO) indication configuration including a set of one or more early CHO indication activation parameters for transmitting an early CHO indication; and transmitting, to a source network node in accordance with the early CHO indication configuration, the early CHO indication prior to at least one CHO execution condition being satisfied, the early CHO indication including a set of parameters for middle data forwarding during a CHO procedure.

### Aspect 2

The method of Aspect 1, wherein the set of parameters for performing the CHO procedure includes one or more predicted target cells, and at least one of a predicted time or a predicted time window, corresponding to at least one of the one or more predicted target cells, during which the CHO execution condition will be satisfied.

### Aspect 3

The method of Aspect 2, wherein the one or more predicted target cells and at least one of the predicted time or the predicted time window are associated with a data forwarding procedure.

### Aspect 4

The method of Aspect 3, wherein the data forwarding procedure includes at least one of a mid-CHO data forwarding procedure, a mid-forwarding procedure, a middle data forwarding procedure, or an intermediate data forwarding procedure.

### Aspect 5

The method of Aspect 4, wherein the data forwarding procedure is an intermediary data forwarding procedure relative to an early data forwarding procedure and a later data forwarding procedure, the early data forwarding procedure occurring during an initial portion of the CHO procedure and the later data forwarding procedure occurring during a final portion of the CHO procedure.

### Aspect 6

The method of any of Aspects 1-5, wherein the CHO procedure is associated with the early CHO indication.

### Aspect 7

The method of any of Aspects 1-6, further comprising: predicting the set of parameters for performing the CHO procedure.

### Aspect 8

The method of Aspect 7, wherein predicting the set of parameters for performing the CHO procedure comprises: predicting the set of parameters using an artificial intelligence (AI) or machine learning (ML) (AI/ML) module.

### Aspect 9

The method of Aspect 7, wherein predicting the set of parameters for performing the CHO procedure comprises: obtaining a set of historical data associated with previous performances of CHO procedures; and predicting the set of parameters for performing the CHO procedure using the set of historical data.

### Aspect 10

The method of Aspect 7, wherein transmitting the early CHO indication is associated with predicting the set of parameters.

### Aspect 11

The method of any of Aspects 1-10, wherein the set of parameters for performing the CHO procedure comprises one or more of: a predicted time at which the at least one CHO execution condition will trigger the CHO procedure, a predicted duration in which the at least one CHO execution condition will be continuously satisfied, one or more candidate target network nodes, one or more respective starting times for performing the CHO procedure corresponding to the one or more candidate target network nodes, or a predicted time for the source network node to perform a data forwarding procedure, or a predicted time window for the source network node to perform a data forwarding procedure.

### Aspect 12

The method of any of Aspects 1-11, further comprising: predicting that the at least one CHO execution condition will be satisfied, wherein transmitting the early CHO indication is associated with predicting that the at least one CHO execution condition will be satisfied.

### Aspect 13

The method of any of Aspects 1-12, wherein the at least one CHO execution condition comprises one or more of: a reference signal received power threshold, a reference signal received quality threshold, a signal-to-interference noise ratio threshold, a radio frequency condition associated with communications between the UE and the source network node, a UE transmission power threshold, a power headroom threshold associated with a UE transmission power, a power headroom threshold, a confidence level condition, a confidence level threshold, an A3 event, an A4 event, an A5 event, an event trigger condition, an absolute threshold, a relative threshold, or a time to trigger.

### Aspect 14

The method of any of Aspects 1-13, further comprising: receiving at least one of: a CHO configuration for a Layer 1 handover via at least one of medium access control (MAC) control element (CE) (MAC-CE) signaling or physical downlink control channel (PDCCH) downlink control information (DCI) signaling, or a CHO configuration for a Layer 3 handover via radio resource control (RRC) signaling.

### Aspect 15

The method of any of Aspects 1-14, wherein receiving the early CHO indication configuration comprises receiving first signaling including the early CHO indication configuration, the method further comprising: receiving second signaling including at least one of a Layer 1 CHO configuration or a Layer 3 CHO configuration.

### Aspect 16

The method of Aspect 15, wherein the first signaling and the second signaling are a same signaling.

### Aspect 17

The method of Aspect 15, wherein the first signaling is different from the second signaling.

### Aspect 18

The method of Aspect 15, wherein at least one of the first signaling or the second signaling includes radio resource control signaling.

### Aspect 19

The method of any of Aspects 1-18, wherein the early CHO indication configuration includes one or more of: a capability parameter of the source network node for performing data forwarding in accordance with an early CHO indication procedure.

### Aspect 20

The method of any of Aspects 1-19, wherein: the early CHO indication configuration includes a set of parameters for performing an early CHO indication procedure, and the set of parameters for performing the early CHO indication procedure includes the set of one or more early CHO indication activation parameters.

### Aspect 21

The method of any of Aspects 1-20, wherein the set of one or more early CHO indication activation parameters includes at least one of: one or more source cell radio frequency conditions, one or more serving cell radio link failure conditions, a serving cell reference signal received power threshold, a reference signal received quality threshold, a signal-to-noise ratio threshold, a source cell radio link failure timer status, a predicted time of radio link failure between the source network node and the UE, an energy mode of the source network node, one or more discontinuous reception parameters, one or more discontinuous transmission parameters, an activation parameter for network energy saving, or a deactivation parameter for network energy saving.

### Aspect 22

The method of any of Aspects 1-21, wherein transmitting the early CHO indication is associated with a radio frequency condition between the UE and the source network node satisfying at least one of the set of one or more early CHO indication activation parameters.

### Aspect 23

The method of any of Aspects 1-22, wherein the CHO procedure comprises at least one of an early CHO indication-based CHO procedure or an enhanced CHO procedure.

### Aspect 24

A method of wireless communication performed by a network node, comprising: transmitting an early conditional handover (CHO) indication configuration including a set of one or more early CHO indication activation parameters for communicating an early CHO indication; and receiving, from a user equipment (UE) in accordance with the early CHO indication configuration, the early CHO indication prior to at least one CHO execution condition being satisfied, the early CHO indication including a set of parameters for performing middle data forwarding during a CHO procedure.

### Aspect 25

The method of Aspect 24, wherein performing the data forwarding during the CHO procedure comprises: forwarding, to one or more target network nodes of the UE, a set of one or more data packets for the UE according to the set of parameters indicated by the early CHO indication.

### Aspect 26

The method of any of Aspects 24-25, further comprising: performing the data forwarding according to the set of parameters indicated by the early CHO indication, the set of parameters including at least one of a predicted CHO execution starting time or a predicted CHO execution starting time window.

### Aspect 27

The method of Aspect 26, wherein performing the data forwarding comprises: forwarding, to one or more target network nodes indicated by the early CHO indication, a set of one or more data packets for the UE.

### Aspect 28

The method of Aspect 27, wherein the one or more target network nodes include one or more predicted target network nodes indicated by the early CHO indication.

### Aspect 29

The method of Aspect 26, wherein performing the data forwarding comprises: performing the data forwarding at a time indicated by the set of parameters indicated by the early CHO indication.

### Aspect 30

The method of Aspect 29, wherein the time includes a predicted time indicated by the early CHO indication.

### Aspect 31

The method of any of Aspects 24-30, wherein the set of parameters for performing the data forwarding during the CHO procedure includes one or more predicted target cells, and at least one of a predicted time or a predicted time window, corresponding to at least one of the one or more predicted target cells, during which the CHO execution condition will be satisfied.

### Aspect 32

The method of Aspect 31, wherein the at least one predicted target cell and the at least one predicted time are associated with the data forwarding.

### Aspect 33

The method of any of Aspects 24-32, wherein the data forwarding includes at least one of a mid-CHO data forwarding procedure, a mid-forwarding procedure, a middle data forwarding procedure, or an intermediate data forwarding procedure.

### Aspect 34

The method of any of Aspects 24-33, wherein the CHO procedure is associated with the early CHO indication.

### Aspect 35

The method of any of Aspects 24-34, wherein the data forwarding includes an intermediary data forwarding procedure relative to an early data forwarding procedure and a later data forwarding procedure, the early data forwarding procedure occurring during an initial portion of the CHO procedure and the later data forwarding procedure occurring during a final portion of the CHO procedure.

### Aspect 36

The method of any of Aspects 24-35, wherein the set of parameters for performing the data forwarding during the CHO procedure comprise a set of predicted parameters.

### Aspect 37

The method of any of Aspects 24-36, wherein the set of parameters for performing the CHO procedure comprises one or more of: a predicted time at which the at least one CHO execution condition will trigger the CHO procedure, a predicted duration in which the at least one CHO execution condition will be continuously satisfied, one or more candidate target network nodes, one or more respective starting times for the CHO procedure corresponding to the one or more candidate target network nodes, or a predicted time for the data forwarding, or a predicted time window for the data forwarding.

### Aspect 38

The method of any of Aspects 24-37, wherein receiving the early CHO indication is associated with a prediction that the at least one CHO execution condition will be satisfied.

### Aspect 39

The method of any of Aspects 24-38, wherein the at least one CHO execution condition comprises one or more of: a reference signal received power threshold, a reference signal received quality threshold, a signal-to-interference noise ratio threshold, a radio frequency condition associated with communications between the UE and the network node, a UE transmission power threshold, a power headroom threshold associated with a UE transmission power, a power headroom threshold, a confidence level condition, a confidence level threshold, an A3 event, an A4 event, an A5 event, an event trigger condition, an absolute threshold, a relative threshold, or a time to trigger.

### Aspect 40

The method of any of Aspects 24-39, further comprising: transmitting at least one of: a CHO configuration for a Layer 1 handover via at least one of medium access control (MAC) control element (CE) (MAC-CE) signaling or physical downlink control channel (PDCCH) downlink control information (DCI) signaling, or a CHO configuration for a Layer 3 handover via radio resource control (RRC) signaling.

### Aspect 41

The method of any of Aspects 24-40, wherein transmitting the early CHO indication configuration comprises transmitting first signaling including the early CHO indication configuration, the method further comprising: transmitting second signaling including at least one of a Layer 1 CHO configuration or a Layer 3 CHO configuration.

### Aspect 42

The method of Aspect 41, wherein the first signaling and the second signaling are a same signaling.

### Aspect 43

The method of Aspect 41, wherein the first signaling is different from the second signaling.

### Aspect 44

The method of Aspect 41, wherein at least one of the first signaling or the second signaling includes radio resource control signaling.

### Aspect 45

The method of any of Aspects 24-44, further comprising: transmitting a CHO configuration including one or more of a set of one or more CHO execution conditions associated with a set of one or more candidate target network nodes, the set of one or more CHO execution conditions including the at least one CHO execution condition.

### Aspect 46

The method of Aspect 45, wherein the CHO configuration indicates the set of one or more candidate target network nodes.

### Aspect 47

The method of any of Aspects 24-46, wherein the early CHO indication configuration includes one or more of: a capability parameter of the network node for performing the data forwarding in accordance with an early CHO indication procedure.

### Aspect 48

The method of any of Aspects 24-47, wherein: the early CHO indication configuration includes a set of parameters for performing an early CHO indication procedure, and the set of parameters for performing the early CHO indication procedure includes the set of one or more early CHO indication activation parameters.

### Aspect 49

The method of any of Aspects 24-48, wherein the set of one or more early CHO indication activation parameters includes at least one of: one or more source cell radio frequency conditions, one or more serving cell radio link failure conditions, a serving cell reference signal received power threshold, a reference signal received quality threshold, a signal-to-noise ratio threshold, a source cell radio link failure timer status, a predicted time of radio link failure between the network node and the UE, an energy mode of the network node, one or more discontinuous reception parameters, one or more discontinuous transmission parameters, an activation parameter for network energy saving, or a deactivation parameter for network energy saving.

### Aspect 50

The method of any of Aspects 24-49, wherein receiving the early CHO indication is associated with a radio frequency condition between the UE and the network node satisfying at least one of the set of one or more early CHO indication activation parameters.

### Aspect 51

The method of any of Aspects 24-50, wherein the CHO procedure comprises at least one of an early CHO indication-based CHO procedure or an enhanced CHO procedure.

### Aspect 52

An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-51.

### Aspect 53

An apparatus for wireless communication at a device, the apparatus comprising one or more memories and one or more processors coupled to the one or more memories, the one or more processors configured to cause the device to perform the method of one or more of Aspects 1-51.

### Aspect 54

An apparatus for wireless communication, the apparatus comprising at least one means for performing the method of one or more of Aspects 1-51.

### Aspect 55

A non-transitory computer-readable medium storing code for wireless communication, the code comprising instructions executable by one or more processors to perform the method of one or more of Aspects 1-51.

### Aspect 56

A non-transitory computer-readable medium storing a set of instructions for wireless communication, the set of instructions comprising one or more instructions that, when executed by one or more processors of a device, cause the device to perform the method of one or more of Aspects 1-51.

### Aspect 57

A device for wireless communication, the device comprising a processing system that includes one or more processors and one or more memories coupled with the one or more processors, the processing system configured to cause the device to perform the method of one or more of Aspects 1-51.

### Aspect 58

An apparatus for wireless communication at a device, the apparatus comprising one or more memories and one or more processors coupled to the one or more memories, the one or more processors individually or collectively configured to cause the device to perform the method of one or more of Aspects 1-51.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive an early conditional handover (CHO) indication configuration including a set of one or more early CHO indication activation parameters for transmitting an early CHO indication; and
transmit, to a source network node in accordance with the early CHO indication configuration, the early CHO indication prior to at least one CHO execution condition being satisfied, the early CHO indication including a set of parameters for middle data forwarding during a CHO procedure.

2. The apparatus of claim 1, wherein the set of parameters for performing the CHO procedure includes one or more predicted target cells, and at least one of a predicted time or a predicted time window, corresponding to at least one of the one or more predicted target cells, during which the CHO execution condition will be satisfied.

3. The apparatus of claim 2, wherein the one or more predicted target cells and at least one of the predicted time or the predicted time window are associated with a data forwarding procedure.

4. The apparatus of claim 3, wherein the data forwarding procedure includes at least one of a mid-CHO data forwarding procedure, a mid-forwarding procedure, a middle data forwarding procedure, or an intermediate data forwarding procedure.

5. The apparatus of claim 3, wherein the data forwarding procedure is an intermediary data forwarding procedure relative to an early data forwarding procedure and a later data forwarding procedure, the early data forwarding procedure occurring during an initial portion of the CHO procedure and the later data forwarding procedure occurring during a final portion of the CHO procedure.

6. The apparatus of claim 1, wherein the CHO procedure is associated with the early CHO indication and includes at least one of a CHO procedure or an early CHO indication-based CHO procedure.

7. The apparatus of claim 1, wherein the one or more processors are further configured to cause the UE to:
predict the set of parameters for performing the CHO procedure.

8. The apparatus of claim 7, wherein the one or more processors, to cause the UE to predict the set of parameters for performing the CHO procedure, are configured to cause the UE to:
predict the set of parameters using an artificial intelligence (AI) or machine learning (ML) (AI/ML) module.

9. The apparatus of claim 7, wherein the one or more processors, to cause the UE to predict the set of parameters for performing the CHO procedure, are configured to cause the UE to:
obtain a set of historical data associated with previous performances of CHO procedures; and
predict the set of parameters for performing the CHO procedure using the set of historical data.

10. The apparatus of claim 7, wherein transmitting the early CHO indication is associated with predicting the set of parameters.

11. A method of wireless communication performed by a user equipment (UE), comprising:
receiving an early conditional handover (CHO) indication configuration for transmitting an early CHO indication; and
transmitting, to a source network node in accordance with the early CHO indication configuration, the early CHO indication prior to at least one CHO execution condition being satisfied, the early CHO indication including a set of parameters for middle data forwarding during a CHO procedure.

12. The method of claim 11, wherein the set of parameters for performing the CHO procedure comprises one or more of:
a predicted time at which the at least one CHO execution condition will trigger the CHO procedure,
a predicted duration in which the at least one CHO execution condition will be continuously satisfied,
one or more candidate target network nodes,
one or more respective starting times for performing the CHO procedure corresponding to the one or more candidate target network nodes,
a predicted time for the source network node to perform a data forwarding procedure, or
a predicted time window for the source network node to perform a data forwarding procedure.

13. The method of claim 11, further comprising:
predicting that the at least one CHO execution condition will be satisfied, wherein transmitting the early CHO indication is associated with predicting that the at least one CHO execution condition will be satisfied.

14. The method of claim 11, wherein the at least one CHO execution condition comprises one or more of:
a reference signal received power threshold,
a reference signal received quality threshold,
a signal-to-interference-plus-noise ratio threshold,
a radio frequency condition associated with communications between the UE and the source network node,
a UE transmission power threshold,
a power headroom threshold associated with a UE transmission power,
a power headroom threshold,
a confidence level condition,
a confidence level threshold,
an A3 event,
an A4 event,
an A5 event,
an event trigger condition,
an absolute threshold,
a relative threshold, or
a time to trigger.

15. The method of claim 11, further comprising:
receiving at least one of:
a CHO configuration for a Layer 1 handover via at least one of medium access control (MAC) control element (CE) (MAC-CE) signaling or physical downlink control channel (PDCCH) downlink control information (DCI) signaling, or a CHO configuration for a Layer 3 handover via radio resource control (RRC) signaling.

16. A non-transitory computer-readable medium storing a set of instructions for wireless communication, the set of instructions comprising:
one or more instructions that, when executed by one or more processors of a user equipment (UE), cause the UE to:
receive an early conditional handover (CHO) indication configuration for transmitting an early CHO indication; and
transmit, to a source network node in accordance with the early CHO indication configuration, the early CHO indication prior to at least one CHO execution condition being satisfied, the early CHO indication including a set of parameters for middle data forwarding during a CHO procedure.

17. The non-transitory computer-readable medium of claim 16, wherein the one or more instructions, that cause the UE to receive the early CHO indication configuration, cause the UE to receive first signaling including the early CHO indication configuration, and further cause the UE to:
receive second signaling including at least one of a Layer 1 CHO configuration or a Layer 3 CHO configuration.

18. The non-transitory computer-readable medium of claim 17, wherein the first signaling and the second signaling are a same signaling.

19. The non-transitory computer-readable medium of claim 17, wherein the first signaling is different from the second signaling.

20. The non-transitory computer-readable medium of claim 16, wherein the early CHO indication configuration includes one or more of:
a capability parameter of the source network node for performing data forwarding in accordance with an early CHO indication procedure, or
a set of parameters for performing an early CHO indication procedure, the set of parameters for performing the early CHO indication procedure includes the set of one or more early CHO indication activation parameters.
